(19) United States
(12) Patent Application Publication
(10) Pub. No.: US 2021/0267231 A1
(43) Pub. Date: Sep. 2, 2021

(54) NOVEL METHOD FOR PREPARING ALPHA-LACTALBUMIN-ENRICHED COMPOSITIONS, RELATED PRODUCTS AND USES E.G. IN INFANT FORMULAS

(71) Applicant: ARLA FOODS AMBA, Viby J (DK)

(72) Inventors: Kasper Bøgelund LAURIDSEN, Silkeborg (DK); Hans BERTELSEN, Videbæk (DK); Behnaz Razi PARJIKOLAEI, Herning (DK); Søren Bang NIELSEN, Herning (DK); Tanja Christine JÆGER, Kibæk (DK); Kåre SØNDERGAARD, Holstebro (DK); Guilherme DE MOURA MACIEL, Herning (DK)

(21) Appl. No.: 17/254,748

(22) PCT Filed: Jun. 26, 2019
(86) PCT No.: PCT/EP2019/066990

§ 371 Date: Dec. 21, 2020

(30) Foreign Application Priority Data
Jun. 27, 2018 (EP) 18180212.5
Jun. 27, 2018 (EP) 18180224.0

(51) Int. Cl. A23J 1/20; A23L 33/00; A23L 33/19; A23L 3/28; A23L 3/30

(52) U.S. Cl. CPC A23J 1/205; A23L 33/40; A23L 3/30; A23L 3/28; A23L 33/19

(57) ABSTRACT

The present invention relates to a new method of producing edible alpha-lactalbumin-enriched protein compositions based on removal of beta-lactoglobulin (BLG) from a whey protein containing feed by selective crystallisation of non-aggregated BLG. The invention furthermore relates to new edible alpha-lactalbumin-enriched protein compositions, uses of these compositions and food products comprising these compositions.

### FIELD OF THE INVENTION

The present invention relates to a new method of producing edible alpha-lactalbumin-enriched protein compositions based on removal of beta-lactoglobulin (BLG) from a whey protein containing feed by selective crystallisation of non-aggregated BLG. The invention furthermore relates to new edible alpha-lactalbumin-enriched protein compositions, uses of these compositions and food products comprising these compositions.

### BACKGROUND OF THE INVENTION

The concept of milk protein fractionation is well-known in the art and has developed during the last decades to an array of technologies for preparing compositions enriched with various milk protein species, each having specific properties and characteristics.

Isolation of alpha-lactalbumin (ALA) from milk serum or whey is the subject of a number of publications and typically involves multiple separation steps and often filtration and/or chromatographic techniques to arrive a purified ALA.

U.S. Pat. No. 5,008,376 describes an ALA separation technique using ultrafiltration. Heat precipitation methods involve the application of heat to the whey at a given pH range for a time period sufficient to promote the flocculation of ALA. Such heat precipitation methods are described in U.S. Pat. No. 5,455,331. Ion exchange methods involve contacting the whey with an anion or cation exchanger so as to selectively retain a protein fraction. Such a process is described in U.S. Pat. No. 5,077,067.

Muller et al (Lait 83, pages 439-451, 2003) describes methods of enriching ALA from acid whey by specific ultrafiltration treatments and optionally by reversible precipitation of ALA. The ALA precipitate is separated from the other whey proteins by e.g. centrifugation and re-dissolved. A good precipitation yield was obtained at 55 degrees C. maintained for 5-10 minutes and at pH 3.9.

### SUMMARY OF THE INVENTION

Accidently, the present inventors made the surprising discovery that ALA may be enriched from crude whey protein solutions by selective crystallisation of BLG and removal of the BLG crystals. This can be done without the use of organic solvents such as toluene. The discovery is contrary to the common general knowledge in the art which teaches that proteins have to be highly purified before one can hope to crystallise them, and that not all proteins can be crystallised.

This discovery has the potential to change the way whey protein is handled and fractionated in the dairy industry and opens up for both efficient and gentle production of ALA-enriched protein compositions which are safe to use as a food ingredient, e.g. for the production of infant formula products.

Thus, an aspect of the invention pertains to a method of preparing an edible, alpha-lactalbumin-enriched whey protein composition, the method comprising the steps of

a) providing a whey protein solution comprising non-aggregated beta-lactoglobulin (BLG), alpha-lactalbumin (ALA) and optionally additional whey protein, said whey protein solution being supersaturated with respect to BLG and having a pH in the range of 5-6,
b) crystallising non-aggregated BLG in the supersaturated whey protein solution, preferably in salting-in mode, and
c) separating the BLG crystals from the remaining mother liquor and recovering at least some of the mother liquor,
d) providing a first composition derived from the recovered mother liquor,
e) optionally, adjusting the pH of the first composition to
i) a pH in the range of 2.5-4.9, or
ii) a pH in the range of 6.1-8.5,
   f) drying:
the first composition obtained from step d) or a protein concentrate thereof, or
the pH-adjusted first composition obtained from step e) or a protein concentrate thereof.

Another aspect of the invention pertains to an edible, ALA-enriched whey protein composition, said composition e.g. obtainable by one or more methods as defined herein.

Yet an aspect of the invention pertains to a method of producing a food product, the method comprising the steps of

a) providing a whey protein solution comprising non-aggregated beta-lactoglobulin (BLG), alpha-lactalbumin (ALA) and optionally additional whey protein, said whey protein solution being supersaturated with respect to BLG and having a pH in the range of 5-6,
b) crystallising non-aggregated BLG in the supersaturated whey protein solution, preferably in salting-in mode, and
c) separating the BLG crystals from the remaining mother liquor and recovering at least some of the mother liquor,
d) providing a first composition derived from the recovered mother liquor,
e) optionally, adjusting the pH of the first composition to
i) a pH in the range of 2.5-4.9, or
ii) a pH in the range of 6.1-8.5,
   f) optionally, drying the first composition obtained from step d) or a protein concentrate thereof or drying the pH-adjusted first composition obtained from step e) or a protein concentrate thereof,
   g) combining:
g1) the first composition obtained from step d) or a protein concentrate thereof,
g2) the pH-adjusted first composition obtained from step e) or a protein concentrate thereof, and/or
g3) the dried composition obtained from step f)
   with one or more ingredients and converting the combination to a food product.

A further aspect of the invention pertains to a food product comprising the ALA-enriched whey protein composition, said food product e.g. obtainable by the method of producing a food product defined herein.

### BRIEF DESCRIPTION OF THE FIGURES

FIG. 1 shows two overlaid chromatograms of a crude whey protein solution (solid line) based on sweet whey and the resulting mother liquor after crystallisation (dashed line). The difference between the solid and the dashed lines is due to removed BLG crystals.

FIG. 2 is a microscope photo of the BLG crystals recovered from Example 2.

FIG. 3 is a chromatogram of recovered BLG crystal from Example 2.

FIG. 4 shows chromatograms of the feed of Example 3 (solid line) and the mother liquor (dashed line) obtained after crystallisation and removal of BLG crystals.

FIG. 5 shows a picture of feed 3 of Example 5 before (left-hand picture) and after (right-hand picture) crystallisation.

FIG. 6 is a schematic illustration of the crystallisation process variant of Example 6 which uses DCF for separation of BLG crystals from the mother liquor.

### DETAILED DESCRIPTION

### Definitions

In the context of the present invention, the term “beta-lactoglobulin” or “BLG” pertains to beta-lactoglobulin from mammal species, e.g. in native, unfolded and/or glycosylated forms and includes the naturally occurring genetic variants. The term furthermore includes aggregated BLG, precipitated BLG and crystalline BLG. When referring to the amount of BLG reference is made to the total amount of BLG including aggregated BLG. The total amount of BLG is determined according to Example 1.21. The term “aggregated BLG” pertains to BLG which is at least partially unfolded and which furthermore has aggregated with other denatured BLG molecules and/or other denatured whey proteins, typically by means of hydrophobic interactions and/or covalent bonds.

BLG is the most predominant protein in bovine whey and milk serum and exists in several genetic variants, the main ones in cow milk being labelled A and B. BLG is a lipocalin protein, and can bind many hydrophobic molecules, suggesting a role in their transport. BLG has also been shown to be able to bind iron via siderophores and might have a role in combating pathogens. A homologue of BLG is lacking in human breast milk.

Bovine BLG is a relatively small protein of approx. 162 amino acid residues with a molecular weight of approx. 18.3-18.4 kDa. Under physiological conditions, it is predominantly dimeric, but dissociates to a monomer below about pH 3, preserving its native state as determined using Nuclear Magnetic Resonance spectroscopy. Conversely, BLG also occurs in tetrameric, octameric and other multimeric aggregation forms under a variety of natural conditions.

In the context of the present invention, the term “non-aggregated beta-lactoglobulin” or “non-aggregated BLG” also pertains to beta-lactoglobulin from mammal species, e.g. in native, unfolded and/or glycosylated forms and includes the naturally occurring genetic variants. However, the term does not include aggregated BLG, precipitated BLG or crystallised BLG. The amount or concentration of non-aggregated BLG is determined according to Example 1.2.

The percentage of non-aggregated BLG relative to total BLG is determined by calculate (m_{total BLG}−m_{non-aggregate BLG})/m_{total BLG}*100%. m_{total BLG} is the concentration or amount of BLG determined according to Example 1.21 and m_{non-aggregated BLG} is the concentration or amount of non-aggregated BLG determined according to Example 1.2.

In the context of the present invention, the term “crystal” pertains to a solid material whose constituents (such as atoms, molecules or ions) are arranged in a highly ordered microscopic structure, forming a crystal lattice that extends in all directions.

In the context of the present invention, the term “BLG crystal” pertains to protein crystals that primarily contain non-aggregated and preferably native BLG arranged in a highly ordered microscopic structure, forming a crystal lattice that extends in all directions. The BLG crystals may e.g. be monolithic or polycrystalline and may e.g. be intact crystals, fragments of crystals, or a combination thereof. Fragments of crystal are e.g. formed when intact crystals are subjected to mechanical shear during processing. Fragments of crystals also have the highly ordered microscopic structure of crystal but may lack the even surface and/or even edges or corners of an intact crystal. See e.g. FIG. 18 of PCT application no. PCT/EP2017/084553 for an example of many intact BLG crystals and FIG. 13 PCT application no. PCT/EP2017/084553 for an example of fragments of BLG crystals. In both cases, the BLG crystal or crystal fragments can be identified visually as well-defined, compact and coherent structures using light microscopy. BLG crystal or crystal fragments are often at least partially transparent. Protein crystals are furthermore known to be birefringent and this optical property can be used to identify unknown particles having a crystal structure. Non-crystalline BLG aggregates, on the other hand, often appear as poorly defined, non-transparent, and as open or porous lumps of irregular size.

In the context of the present invention, the term “crystallise” pertains to the formation of protein crystals. Crystallisation may e.g. happen spontaneously or be initiated by the addition of crystallisation seeds.

“Mother Liquor”

In the context of the present invention the term “mother liquor” pertains to the whey protein solution that remains after BLG has been crystallised and the BLG crystals have be at least partially removed. The mother liquor may still contain some BLG crystals but normally only small BLG crystals that have escaped the separation.

In the context of the present invention, the term “edible composition” pertains to a composition that is safe for human consumption and use as a food ingredient and that does not contain problematic amounts of toxic components, such as toluene or other unwanted organic solvents.

In the context of the present invention, the term “ALA” or “alpha-lactalbumin” pertains to alpha-lactalbumin from mammal species, e.g. in native and/or glycosylated forms and includes the naturally occurring genetic variants. The term furthermore includes aggregated ALA and precipitated BLG. When referring to the amount of ALA reference is made to the total amount of ALA including e.g. aggregated ALA. The total amount of ALA is determined according to Example 1.21. The term “aggregated ALA” pertains to ALA which typically is at least partially unfolded and which furthermore has aggregated with other denatured ALA molecules and/or other denatured whey proteins, typically by means of hydrophobic interactions and/or covalent bonds.

Alpha-lactalbumin (ALA) is a protein present in the milk of almost all mammalian species. ALA forms the regulatory subunit of the lactose synthase (LS) heterodimer and β-1,4-galactosyltransferase (beta4Gal-T1) forms the catalytic component. Together, these proteins enable LS to produce lactose by transferring galactose moieties to glucose. One of the main structural differences with beta-lactoglobulin is that ALA does not have any free thiol group that can serve as the starting-point for a covalent aggregation reaction.

In the context of the present invention, the term “non-aggregated ALA” also pertains to ALA from mammal species, e.g. in native, unfolded and/or glycosylated forms and includes the naturally occurring genetic variants. However, the term does not include aggregated ALA or precipitated ALA. The amount or concentration of non-aggretated BLG is determined according to Example 1.2.

The percentage of non-aggregated ALA relative to total ALA is determined by calculate (m_{total ALA}−m_{non-aggregate ALA})/m_{total ALA}*100%. m_{total ALA} is the concentration or amount of ALA determined according to Example 1.21 and m_{non-aggregated ALA} is the concentration or amount of non-aggregated ALA determined according to Example 1.2.

In the context of the present invention a composition which is “ALA-enriched” or “enriched with respect to ALA” has a higher weight percentage of ALA relative to total protein than the feed from which is was derived.

In the context of the present invention, the term “caseinomacropeptide” or “CMP” pertains to the hydrophilic peptide, residue 106-169, originated from the hydrolysis of “κ-CN” or “kappa-casein” from mammal species, e.g. in native and/or glycosylated forms and includes the naturally occurring genetic variants, by an aspartic proteinase, e.g. chymosin.

The term “whey” pertains to the liquid phase that is left after the casein of milk has been precipitated and removed. Casein precipitation may e.g. be accomplished by acidification of milk and/or by use of rennet enzyme. Several types of whey exist, such as “sweet whey”, which is the whey product produced by rennet-based precipitation of casein, and “acid whey” or “sour whey”, which is the whey product produced by acid-based precipitation of casein. Acid-based precipitation of casein may e.g. be accomplished by addition of food acids or by means of bacterial cultures.

The term “milk serum” pertains to the liquid which remains when casein and milk fat globules have been removed from milk, e.g. by microfiltration or large pore ultrafiltration. Milk serum may also be referred to as “ideal whey”.

The term “milk serum protein” or “serum protein” pertains to the protein which is present in the milk serum.

In the context of the present invention, the term “whey protein” pertains to protein that is found in whey or in milk serum. Whey protein may be a subset of the protein species found in whey or milk serum, and even a single whey protein species or it may be the complete set of protein species found in whey or/and in milk serum.

The term casein pertains to casein protein found in milk and encompasses both native micellar casein as found in raw milk, the individual casein species, and caseinates.

In the context of the present invention, a liquid which is “supersaturated” or “supersaturated with respect to BLG” contains a concentration of dissolved, non-aggregated BLG which is above the saturation point of non-aggregated BLG in that liquid at the given physical and chemical conditions. The term “supersaturated” is well-known in the field of crystallisation (see e.g. Gérand Coquerela, “Crystallization of molecular systems from solution: phase diagrams, supersaturation and other basic concepts”, Chemical Society Reviews, p. 2286-2300, Issue 7, 2014) and supersaturation can be determined by a number of different measurement techniques (e.g. by spectroscopy or particle size analysis). In the context of the present invention, supersaturation with respect to BLG is determined by the following procedure.

Procedure for Testing Whether a Liquid at a Specific Set of Conditions is Supersaturated with Respect to BLG:

a) Transfer a 50 ml sample of the liquid to be tested to a centrifuge tube (VWR Catalogue no. 525-0402) having a height of 115 mm, an inside diameter of 25 mm and a capacity of 50 mL. Care should be taken to keep the sample and subsequent fractions thereof at the original physical and chemical conditions of the liquid during steps a)-h).
b) The sample is immediately centrifuged at 3000 g for 3.0 minutes with max. 30 seconds acceleration and max 30 seconds deceleration.
c) Immediately after the centrifugation, transfer as much as possible of the supernatant (without disturbing the pellet if a pellet has formed) to a second centrifuge tube (same type as in step a)
d) Take a 0.05 mL subsample of the supernatant (subsample A)
e) Add 10 mg of BLG crystals (at least 98% pure, non-aggregated BLG relative to total solids) having a particle size of at most 200 micron to a second centrifuge tube and agitate the mixture.
f) Allow the second centrifuge tube to stand for 60 minutes at the original temperature.
g) Immediately after step f), centrifuge the second centrifuge tube at 500 g for 10 minutes and then take another 0.05 mL subsample of the supernatant (subsample B).
h) Recover the centrifugation pellet of step g) if there is one, resuspend it in milliQ water and immediately inspect the suspension for presence of crystals that are visible by microscopy.
i) Determine the concentration of non-aggregated BLG in subsamples A and B using the method outlined in Example 1.2—the results are expressed as % BLG w/w relative to the total weight of the subsamples. The concentration of non-aggregated BLG of subsample A is referred to as C_{BLG, A}, and the concentration of non-aggregated BLG of subsample B is referred to as C_{BLG, B}.
j) The liquid from which the sample of step a) was taken was supersaturated (at the specific conditions) if c_{BLG, B} is lower than c_{BLG, A} and if crystals are observed in step i).

In the context of the present invention, the terms “liquid” and “solution” encompass both compositions that are free of particulate matter and compositions that contain a combination of liquid and solid and/or semi-solid particles, such as e.g. protein crystals or other protein particles. A “liquid” or a “solution” may therefore be a suspension or even a slurry. However, a “liquid” and “solution” are preferably pumpable.

In the context of the present invention, the terms “whey protein concentrate” (WPC) and “serum protein concentrate” (SPC) pertain to dry or aqueous compositions which contain a total amount of protein of 20-89% w/w relative to total solids.

A WPC or an SPC preferably contains:

20-89% w/w protein relative to total solids,

15-70% w/w non-aggregated BLG relative to total protein,

8-50% w/w ALA relative to total protein, and

0-40% w/w CMP relative to protein.

Alternatively, but also preferred, a WPC or an SPC may contain:

20-89% w/w protein relative to total solids,

15-90% w/w non-aggregated BLG relative to total protein,

4-50% w/w ALA relative to total protein, and

0-40% w/w CMP relative to protein.

Preferably, a WPC or an SPC contains:

20-89% w/w protein relative to total solids,

15-80% w/w non-aggregated BLG relative to total protein,

4-50% w/w ALA relative to total protein, and

0-40% w/w CMP relative to protein.

More preferably a WPC or an SPC contains:

70-89% w/w protein relative to total solids,

30-90% w/w non-aggregated BLG relative to total protein,

4-35% w/w ALA relative to total protein, and

0-25% w/w CMP relative to protein.

SPC typically contain no CMP or only traces of CMP.

The terms “whey protein isolate” (WPI) and “serum protein isolate” (SPI) pertain to dry or aqueous compositions which contain a total amount of protein of 90-100% w/w relative to total solids.

A WPI or an SPI preferably contains:

90-100% w/w protein relative to total solids,

15-70% w/w non-aggregated BLG relative to total protein,

8-50% w/w ALA relative to total protein, and

0-40% w/w CMP relative to total protein.

Alternatively, but also preferred, a WPI or an SPI may contain:

90-100% w/w protein relative to total solids,

30-95% w/w non-aggregated BLG relative to total protein,

4-35% w/w ALA relative to total protein, and

0-25% w/w CMP relative to total protein.

More preferably a WPI or an SPI may contain:

90-100% w/w protein relative to total solids,

30-90% w/w non-aggregated BLG relative to total protein,

4-35% w/w ALA relative to total protein, and

0-25% w/w CMP relative to total protein.

SPI typically contain no CMP or only traces of CMP.

The terms “consists essentially of” and “consisting essentially of” mean that the claim or feature in question encompasses the specified materials or steps and those that do not materially affect the basic and novel characteristic(s) of the claimed invention.

In the context of the present invention, the phrase “Y and/or X” means “Y” or “X” or “Y and X”. Along the same line of logic, the phrase “n₁, n₂, . . . , nᵢ₋₁, and/or nᵢ” means “n₁” or “n₂” or . . . or “nₙ₋₁” or “nᵢ” or any combination of the components: n₁, n₂, . . . nₙ₋₁, and nᵢ.

In the context of the present invention, the term “dry” or “dried” means that the composition or product in question comprises at most 10% w/w water, preferably at most 6% w/w and more preferably even less.

In the context of the present invention, the term “physical microbial reduction” pertains to physical interaction with a composition which results in reduction of the total amount of viable microorganisms of the composition. The term does not encompass addition of chemicals that result in killing of microorganisms. The term furthermore does not encompass the heat exposure to which the atomized droplets of liquid are exposed to during spray-drying but include possible pre-heating prior to spray-drying.

In the context of the present invention, the pH of a powder refers to the pH of 10 g of the powder mixed into 90 g demineralised water and is measured according to Example 1.8.

In the context of the present invention, the weight percentage (% w/w) of a component of a certain composition, product, or material means the weight percentage of that component relative to the weight of the specific composition, product, or material unless another reference (e.g. total solids or total protein) is specifically mentioned.

In the context of the present invention, the term “weight ratio” between component X and component Y means the value obtained by the calculation m_{X}/m_{Y} wherein m_{X} is the amount (weight) of components X and m_{Y} is the amount (weight) of components Y.

In the context of the present invention, the term “at least pasteurisation” pertains to a heat-treatment which has microbial killing effect equal to or higher than a heat-treatment of 70 degrees C. for 10 seconds. The reference for determining the bacteria killing effect is E. coli O157:H7.

In the context of the present invention, the term “whey protein solution” is used to describe the special aqueous whey protein composition that is supersaturated with respect to BLG in salting-in mode and useful for preparing BLG crystals.

In the context of the present invention, the term “whey protein feed” pertains to whey protein solution is derived. The whey protein feed is typically a WPC, a WPI, an SPC or an SPI.

In the context of the present invention, the term “sterile” means that the sterile composition or product in question does not contain any viable microorganisms and therefore is devoid of microbial growth during storage at room temperature. A composition that has been sterilised is sterile.

When a liquid, such as a beverage preparation, is sterilized and packaged aseptically in a sterile container it typically has a shelf life of at least six months at room temperature. The sterilization treatment kills spores and microorganisms that could cause spoilage of the liquid.

In the context of the present invention the term “protein fraction” relates to proteins of the composition in question e.g. the proteins of a powder or a beverage preparation.

In the context of the present invention the term “minerals” as used herein, unless otherwise specified, refers to any one of major minerals, trace or minor minerals, other minerals, and combinations thereof. Major minerals include calcium, phosphorus, potassium, sulfur, sodium, chlorine, magnesium. Trace or minor minerals include iron, cobalt, copper, zinc, molybdenum, iodine, selenium, manganese and other minerals include chromium, fluorine, boron, lithium, and strontium.

In the context of the present invention the terms “lipid”, “fat”, and “oil” as used herein unless otherwise specified, are used interchangeably to refer to lipid materials derived or processed from plants or animals. These terms also include synthetic lipid materials so long as such synthetic materials are suitable for human consumption.

In the context of the present invention the term “transparent” encompasses a beverage preparation having a visibly clear appearance and which allows light to pass and through which distinct images appear. A transparent beverage has a turbidity of at most 200 NTU.

In the context of the present invention the terms “opaque” encompasses a beverage preparation having a visibly unclear appearance and it has a turbidity of more than 200 NTU.

In the context of the present invention, a “protein concentrate of” a first solution or a “protein concentrate thereof” pertain to a second solution which has i) a higher weight percentage of total protein on a total solids basis and/or ii) a higher weight percentage of total protein on a total weight basis than the first solution. A protein concentrate may e.g. be obtained by removing only water from the first solution and/or by removing non-protein solids such as e.g. carbohydrates and salts. The protein concentrate preferably has substantially the same pH as the first solution, i.e. preferably at most 0.3 pH-value above or below the pH of the first solution, and more preferably at most 0.2 pH-value above or below the pH of the first solution, and even more preferably at most 0.1 pH-value above or below the pH of the first solution.

In the context of the present invention, the term “additional protein” means a protein that is not BLG or ALA. The additional protein that is present in the whey protein solution typically comprises one or more of the non-BLG/ALA proteins that are found in milk serum or whey. Non-limiting examples of such proteins are, bovine serum albumin, immunoglobulins, caseinomacropeptide (CMP), osteopontin, lactoferrin, and milk fat globule membrane proteins.

The whey protein solution may therefore preferably contain at least one additional whey protein selected from the group consisting of bovine serum albumin, immunoglobulins, caseinomacropeptide (CMP), osteopontin, lactoferrin, milk fat globule membrane proteins, and combinations thereof.

In the context of the present invention the term “mother liquor” pertains to the whey protein solution that remains after non-aggregated BLG has been crystallised and the BLG crystals have be at least partially removed. The mother liquor may still contain some BLG crystals but normally only small BLG crystals that have escaped the separation.

As said, an aspect of the invention pertains to a method of preparing an edible, alpha-lactalbumin-enriched whey protein composition, the method comprising the steps of

a) providing a whey protein solution comprising non-aggregated BLG, ALA and optionally additional whey protein, said whey protein solution is supersaturated with respect to BLG and has a pH in the range of 5-6,
b) crystallising non-aggregated BLG in the supersaturated whey protein solution, preferably in salting-in mode, and
c) separating the BLG crystals from the remaining mother liquor and recovering at least some of the mother liquor,
d) providing a first composition derived from the recovered mother liquor and optionally also the used washing liquid,
e) optionally, adjusting the pH of the first composition to
i) a pH in the range of 2.5-4.9, or
ii) a pH in the range of 6.1-8.5,
   f) drying:
the first composition obtained from step d) or a protein concentrate thereof, or
the pH-adjusted first composition obtained from step e) or a protein concentrate thereof.

In some preferred embodiments of the invention, the method furthermore comprises physical microbial reduction, preferably performed after the pH adjustment of step e) and prior to the drying of step f).

As said, step a) of the present invention involves providing a whey protein solution which comprises non-aggregated BLG, ALA, and at least an additional whey protein.

In some embodiments of the invention, the whey protein solution comprises at most 10% w/w casein relative to the total amount of protein, preferably at most 5% w/w, more preferably at most 1% w/w, and even more preferably at most 0.5% casein relative to the total amount of protein. In some preferred embodiments of the invention, the whey protein solution does not contain any detectable amount of casein.

In some preferred embodiments of the invention, the whey protein solution of step a) comprises at least 5% w/w additional whey protein relative to the total amount of protein. Preferably, the whey protein solution of step a) comprises at least 10% w/w additional whey protein relative to the total amount of protein. More preferably, the whey protein solution of step a) comprises at least 15% w/w additional whey protein relative to the total amount of protein. Even more preferably, the whey protein solution of step a) comprises at least 20% w/w additional whey protein relative to the total amount of protein. Most preferably, the whey protein solution of step a) may comprise at least 30% w/w additional whey protein relative to the total amount of protein.

In other preferred embodiments of the invention, the whey protein solution of step a) comprises at least 1% w/w additional whey protein relative to the total amount of protein. Preferably, the whey protein solution of step a) comprises at least 2% w/w additional whey protein relative to the total amount of protein. Even more preferably, the whey protein solution of step a) comprises at least 3% w/w additional whey protein relative to the total amount of protein. Most preferably, the whey protein solution of step a) may comprise at least 4% w/w additional whey protein relative to the total amount of protein.

In yet other preferred embodiments of the invention, the whey protein solution of step a) comprises at least 35% w/w additional whey protein relative to the total amount of protein. Preferably, the whey protein solution of step a) may comprise at least 40% w/w additional whey protein relative to the total amount of protein. More preferably, the whey protein solution of step a) may e.g. comprise at least 45% w/w additional whey protein relative to the total amount of protein. Even more preferably, the whey protein solution of step a) may comprise at least 50% w/w additional whey protein relative to the total amount of protein.

In some preferred embodiments of the invention, the whey protein solution of step a) comprises in the range of 5-90% w/w additional whey protein relative to the total amount of protein. Preferably, the whey protein solution of step a) may comprise in the range of 10-80% w/w additional whey protein relative to the total amount of protein. The whey protein solution of step a) may e.g. comprise in the range of 20-70% w/w additional whey protein relative to the total amount of protein. Preferably, the whey protein solution of step a) comprises in the range of 30-70% w/w additional whey protein relative to the total amount of protein.

As said, the present inventors have found that it is possible to crystallise non-aggregated BLG without the use of organic solvents. This purification approach can also be used to refine preparations containing whey protein, which preparations have already been subjected to some BLG purification and provides simple methods of increasing the purity of non-aggregated BLG even further. Thus, in some preferred embodiments of the invention, the whey protein solution of step a) comprises in the range of 1-20% w/w additional whey protein relative to the total amount of protein. Preferably, the whey protein solution of step a) may comprise in the range of 2-15% w/w additional whey protein relative to the total amount of protein. Even more preferably, the whey protein solution of step a) may e.g. comprise in the range of 3-10% w/w additional whey protein relative to the total amount of protein.

In some embodiments of the invention, the whey protein solution of step a) comprises at least 5% w/w ALA relative to the total amount of protein. Preferably, the whey protein solution of step a) comprises at least 10% w/w ALA relative to the total amount of protein. Even more preferably, the whey protein solution of step a) comprises at least 15% w/w ALA relative to the total amount of protein. Alternatively, the whey protein solution of step a) may comprise at least 20% w/w ALA relative to the total amount of protein.

In some preferred embodiments of the invention, the whey protein solution of step a) comprises at least 25% w/w ALA relative to the total amount of protein. Preferably, the whey protein solution of step a) comprises at least 30% w/w ALA relative to the total amount of protein. The whey protein solution of step a) preferably comprises at least 35% w/w ALA relative to the total amount of protein. Even more preferably, the whey protein solution of step a) may comprise at least 40% w/w ALA relative to the total amount of protein.

In some preferred embodiments of the invention, the whey protein solution of step a) comprises in the range of 5-95% w/w ALA relative to the total amount of protein. Preferably, the whey protein solution of step a) comprises in the range of 5-70% w/w ALA relative to the total amount of protein. Even more preferably, the whey protein solution of step a) may comprise in the range of 10-60% w/w ALA relative to the total amount of protein. The whey protein solution of step a) preferably comprises in the range of 12-50% w/w ALA relative to the total amount of protein. Even more preferred, the whey protein solution of step a) may comprise in the range of 20-45% w/w ALA relative to the total amount of protein.

It is often preferred that at least some of the ALA of the compositions and products mentioned herein contains at least some non-aggregated ALA. Preferably at least 25% of the ALA is non-aggregated ALA. More preferably at least at least 50% of the ALA is non-aggregated ALA. Even more preferred at least 70% of the ALA is non-aggregated ALA. Most preferred, at least 90% of the ALA is non-aggregated ALA. Even more preferred approx. 100% of the ALA may be non-aggregated ALA.

In some preferred embodiments of the invention, the whey protein solution of step a) has a weight ratio between non-aggregated BLG and ALA of at least 0.01. Preferably, the whey protein solution of step a) has a weight ratio between non-aggregated BLG and ALA of at least 0.5. Even more preferably, the whey protein solution of step a) has a weight ratio between non-aggregated BLG and ALA of at least 1, such as e.g. at least 2. For example, the whey protein solution of step a) may have a weight ratio between non-aggregated BLG and ALA of at least 3. Amounts and concentrations of non-aggregated BLG and other proteins in the whey protein solution and the whey protein feed all refer to dissolved protein and do not include precipitated or crystallised protein.

In some preferred embodiments of the invention, the whey protein solution of step a) has a weight ratio between non-aggregated BLG and ALA in the range of 0.01-20. Preferably, the whey protein solution of step a) has a weight ratio between non-aggregated BLG and ALA in the range of 0.2-10. Even more preferably, the whey protein solution of step a) has a weight ratio between non-aggregated BLG and ALA in the range of 0.5-4. For example, the whey protein solution of step a) may have a weight ratio between non-aggregated BLG and ALA in the range of 1-3.

In some preferred embodiments of the invention, the whey protein solution of step a) comprises at least 1% w/w non-aggregated BLG relative to the total amount of protein. Preferably, the whey protein solution of step a) comprises at least 2% w/w non-aggregated BLG relative to the total amount of protein. Even more preferably, the whey protein solution of step a) comprises at least 5% w/w non-aggregated BLG relative to the total amount of protein. Preferably, the whey protein solution of step a) may comprise at least 10% w/w non-aggregated BLG relative to the total amount of protein.

In some preferred embodiments of the invention, the whey protein solution of step a) comprises at least 12% w/w non-aggregated BLG relative to the total amount of protein. For example, the whey protein solution of step a) may comprise at least 15% w/w non-aggregated BLG relative to the total amount of protein. The whey protein solution of step a) may e.g. comprise at least 20% w/w non-aggregated BLG relative to the total amount of protein. Alternatively, the whey protein solution of step a) may comprise at least 30% w/w non-aggregated BLG relative to the total amount of protein.

In some particularly preferred embodiments of the invention, the whey protein solution of step a) comprises at most 95% w/w non-aggregated BLG relative to the total amount of protein. Preferably, the whey protein solution of step a) may comprise at most 90% w/w non-aggregated BLG relative to the total amount of protein. More preferably, the whey protein solution of step a) may e.g. comprise at most 85% w/w non-aggregated BLG relative to the total amount of protein. Even more preferably, the whey protein solution of step a) may e.g. comprise at most 80% w/w non-aggregated BLG relative to the total amount of protein. Preferably, the whey protein solution of step a) may comprise at most 78% w/w non-aggregated BLG relative to the total amount of protein. Preferably, the whey protein solution of step a) may comprise at most 75% w/w non-aggregated BLG relative to the total amount of protein.

In some preferred embodiments of the invention, the whey protein solution of step a) comprises in the range of 1-95% w/w non-aggregated BLG relative to the total amount of protein. Preferably, the whey protein solution of step a) may comprise in the range of 5-90% w/w non-aggregated BLG relative to the total amount of protein. More preferably the whey protein solution of step a) comprises in the range of 10-85% w/w non-aggregated BLG relative to the total amount of protein. Even more preferably the whey protein solution of step a) comprises in the range of 10-80% w/w non-aggregated BLG relative to the total amount of protein. Most preferably, the whey protein solution of step a) may comprise in the range of 20-70% w/w non-aggregated BLG relative to the total amount of protein.

In other preferred embodiments of the invention, the whey protein solution of step a) comprises in the range of 10-95% w/w non-aggregated BLG relative to the total amount of protein. Preferably, the whey protein solution of step a) may comprise in the range of 12-90% w/w non-aggregated BLG relative to the total amount of protein. More preferably the whey protein solution of step a) comprises in the range of 15-85% w/w non-aggregated BLG relative to the total amount of protein. Even more preferably the whey protein solution of step a) comprises in the range of 15-80% w/w non-aggregated BLG relative to the total amount of protein. Most preferably, the whey protein solution of step a) may comprise in the range of 30-70% w/w non-aggregated BLG relative to the total amount of protein.

In some preferred embodiments of the invention, the whey protein solution of step a) comprises at least 0.4% w/w non-aggregated BLG relative to the weight of the whey protein solution. Preferably the whey protein solution comprises at least 1.0% w/w non-aggregated BLG. More preferably, the whey protein solution comprises at least 2.0% w/w non-aggregated BLG. It is even more preferred that the whey protein solution comprises at least 4% w/w non-aggregated BLG.

Higher concentrations of non-aggregated BLG are even more preferred and preferably the whey protein solution comprises at least 6% w/w non-aggregated BLG. More preferably, the whey protein solution comprises at least 10% w/w non-aggregated BLG. It is even more preferred that the whey protein solution comprises at least 15% w/w non-aggregated BLG.

In some preferred embodiments of the invention, the whey protein solution of step a) comprises in the range of 0.4-40% w/w non-aggregated BLG relative to the weight of the whey protein solution. Preferably the whey protein solution comprises in the range of 1-35% w/w non-aggregated BLG. More preferably the whey protein solution comprises in the range of 4-30% w/w non-aggregated BLG. It is even more preferred that the whey protein solution comprises in the range of 10-25% w/w non-aggregated BLG.

Any suitable whey protein source may be used to prepare the whey protein solution. In some preferred embodiments of the invention, the whey protein solution comprises, or even consists of, a milk serum protein concentrate, whey protein concentrate, milk serum protein isolate, whey protein isolate, or a combination thereof.

It is preferred that the whey protein solution is a demineralised whey protein solution.

In this context, the term demineralised means that the conductivity of the whey protein solution is at most 15 mS/cm, and preferably at most 10 mS/cm, and even more preferably at most 8 mS/cm. The UF permeate conductivity of a demineralised whey protein solution is preferably at most 7 mS/cm, more preferably at most 4 mS/cm, and even more preferably at most 1 mS/cm.

It is particularly preferred that the whey protein solution is a demineralised milk serum protein concentrate, a demineralised milk serum protein isolate, a demineralised whey protein concentrate, or a demineralised whey protein isolate.

In some particularly preferred embodiments of the invention, the whey protein solution comprises, or even consists of, a demineralised and pH adjusted milk serum protein concentrate, whey protein concentrate, milk serum protein isolate, whey protein isolate, or a combination thereof.

The whey protein solution may for example comprise, or even consist of, a demineralised milk serum protein concentrate. Alternatively, the whey protein solution may comprise, or even consist of, a demineralised whey protein concentrate. Alternatively, the whey protein solution may comprise, or even consist of, a demineralised milk serum protein isolate. Alternatively, the whey protein solution may comprise, or even consist of, a demineralised whey protein isolate.

The protein of the whey protein solution is preferably derived from mammal milk, and preferably from the milk of a ruminant such as e.g. cow, sheep, goat, buffalo, camel, llama, mare and/or deer. Protein derived from bovine (cow) milk is particularly preferred. The BLG and the additional whey protein are therefore preferably bovine BLG and bovine whey protein.

The protein of the whey protein solution is preferably as close to its native state as possible and preferably has only been subjected to gentle heat-treatments, if any at all.

In some preferred embodiments of the invention, the non-aggregated BLG of the whey protein solution has a degree of lactosylation of at most 1. Preferably, the non-aggregated BLG of the whey protein solution has a degree of lactosylation of at most 0.6. More preferably, the non-aggregated BLG of the whey protein solution has a degree of lactosylation of at most 0.4. Even more preferably, the non-aggregated BLG of the whey protein solution has a degree of lactosylation of at most 0.2. Most preferably, the non-aggregated BLG of the whey protein solution has a degree of lactosylation of at most 0.1, such as e.g. preferably at most 0.01.

The degree of lactosylation of BLG is determined according to Czerwenka et al (3. Agric. Food Chem., Vol. 54, No. 23, 2006, pages 8874-8882).

In some preferred embodiments of the invention, the whey protein solution has a furosine value of at most 80 mg/100 g protein. Preferably, the whey protein solution has a furosine value of at most 40 mg/100 g protein. More preferably, the whey protein solution has a furosine value of at most 20 mg/100 g protein. Even more preferably, the whey protein solution has a furosine value of at most 10 mg/100 g protein. Most preferably, the whey protein solution has a furosine value of at most 5 mg/100 g protein, such as e.g. preferably a furosine value of 0 mg/100 g protein.

The whey protein solution typically contains other components in addition to protein. The whey protein solution may contain other components that are normally found in whey or milk serum, such as e.g. minerals, carbohydrate, and/or lipid. Alternatively or additionally, the whey protein solution may contain components that are not native to the whey or milk serum. However, such non-native components should preferably be safe for use in food production and preferably also for human consumption.

The present method is particularly advantageous for separating non-aggregated BLG from crude whey protein solutions that contain other solids than non-aggregated BLG.

The whey protein solution may for example contain carbohydrates, such as e.g. lactose, oligosaccharides and/or hydrolysis products of lactose (i.e. glucose and galactose). The whey protein solution may e.g. contain carbohydrate in the range of 0-40% w/w, such as in the range of 1-30% w/w, or in the range of 2-20% w/w.

In some preferred embodiments of the invention, the whey protein solution contains at most 20% w/w carbohydrate, preferably at most 10% w/w carbohydrate, more preferably at most 5% w/w carbohydrate, and even more preferably at most 2% w/w carbohydrate.

The whey protein solution may also comprise lipid, e.g. in the form of triglyceride and/or other lipid types such as phospholipids.

In some embodiments of the invention, the whey protein solution of step a) comprises a total amount of lipid of at most 15% w/w relative to total solids. Preferably, the whey protein solution of step a) comprises a total amount of lipid of at most 10% w/w relative to total solids. More preferably, the whey protein solution of step a) comprises a total amount of lipid of at most 6% w/w relative to total solids. Even more preferably, the whey protein solution of step a) comprises a total amount of lipid of at most 1.0% w/w relative to total solids. Most preferably, the whey protein solution of step a) comprises a total amount of lipid of at most 0.5% w/w relative to total solids.

The total amount of protein of the whey protein solution is typically at least 1% w/w relative to the weight of the whey protein solution. Preferably, the total amount of protein of the whey protein solution is at least 5% w/w. More preferably, the total amount of protein of the whey protein solution is at least 10% w/w. Even more preferably, the total amount of protein of the whey protein solution is at least 15% w/w.

In some preferred embodiments of the invention, the total amount of protein of the whey protein solution is in the range of 1-50% w/w. Preferably, the total amount of protein of the whey protein solution is in the range of 5-40% w/w. More preferred, the total amount of protein of the whey protein solution is in range of 10-30% w/w. Even more preferred, the total amount of protein of the whey protein solution is in the range of 15-25% w/w.

The total amount of protein of the whey protein solution is determined according to Example 1.1.

The whey protein solution is typically prepared by subjecting a whey protein feed to one or more adjustments which form the whey protein solution which is supersaturated with respect to BLG.

The feed is preferably a WPC, a WPI, an SPC, an SPI, or a combination thereof.

In the context of the present invention, the term “whey protein feed” pertains to the composition that is transformed to the whey protein solution supersaturated with respect to BLG. The whey protein feed is typically an aqueous liquid comprising non-aggregated BLG, ALA, and at least one additional whey protein, but is normally not supersaturated with respect to BLG.

The embodiments relating to the chemical composition of the whey protein solution equally apply to the whey protein feed. However, typically at least one parameter of the whey protein feed is set to avoid supersaturation or at least spontaneous crystallisation.

In some preferred embodiments of the invention, the supersaturated whey protein solution is prepared by subjecting the whey protein feed to one or more of the following adjustments:
Adjusting the pH,
Reducing the conductivity
Reducing the temperature
Increasing the protein concentration
Adding an agent that reduces the water activity
Modifying the ion composition

In some preferred embodiments of the invention, the preparation of the whey protein solution involves adjusting the pH of the whey protein feed to a pH in the range of 5-6.

All pH values are measured using a pH glass electrode and are normalised to 25 degrees C.

The whey protein solution may for example have a pH in the range of 4.9-6.1. The pH of the whey protein solution may e.g. be in the range of 5.0-6.1. Alternatively, the pH of the whey protein solution may be in the range of 5.1-6.1. Preferably, the pH of the whey protein solution is in the range of 5.1-6.0.

In some preferred embodiments of the invention, the pH of the whey protein solution is in the range of 5.0-6.0. Preferably, the pH of the whey protein solution is in the range of 5.1-6.0.

More preferably the pH of the whey protein solution is in the range of 5.1-5.9. Even more preferably, the pH of the whey protein solution may be in the range of 5.2-5.9. Most preferably, the pH of the whey protein solution is in the range of 5.2-5.8.

The pH is preferably adjusted using food acceptable acids and/or bases. Food acceptable acids are particularly preferred, such as e.g. carboxylic acids. Useful examples of such acids are e.g. hydrochloric acid, sulfuric acid, phosphoric acid, acetic acid, maleic acid, tartaric acid, lactic acid, citric acid, or gluconic acid, and/or mixtures thereof.

In some preferred embodiments of the invention, the pH is adjusted using a lactone, such as e.g. D-glucono-delta-lactone, which slowly hydrolyses and at the same time reduces the pH of the aqueous liquid containing it. The target pH after the hydrolysis of the lactone has ended can be calculated precisely.

Useful examples of food-acceptable bases are e.g. hydroxide sources such as e.g. sodium hydroxide, potassium hydroxide, calcium hydroxide, salts of food acids such as e.g. tri-sodium citrate, and/or combinations thereof.

In other preferred embodiments of the invention, the pH is adjusted by addition of cation exchange material on its H⁺ form. Bead-type/large particle type cation exchange material is easily removed from the whey protein solution prior to the crystallisation or even after the crystallisation. Adjustment of pH by addition of cation exchange material on its H⁺ form is particularly advantageous in the present invention as it reduced the pH without adding negative counter ions that significantly affects the conductivity of the whey protein feed.

In some preferred embodiments of the invention, the preparation of the whey protein solution involves reducing the conductivity of the whey protein feed.

Conductivity values mentioned herein have been normalised to 25 degrees C. unless it is specified otherwise.

The inventors have found that reducing the conductivity of the whey protein solution leads to a higher yield of BLG crystals. The minimum obtainable conductivity of the whey protein solution depends on the composition of the protein fraction and the lipid fraction (if any). Some protein species, such as e.g. caseinomacropeptide (CMP), contribute more to the conductivity than other protein species. It is therefore preferable that the conductivity of the whey protein feed is brought near the level where protein and the counter ions of the protein are the main contributors to the conductivity. The reduction of conductivity often involves removal of at least some of the small, free ions that are present in liquid phase and not tightly bound to the proteins.

It is often preferred that the whey protein solution has a conductivity of at most 10 mS/cm. In some preferred embodiments of the invention, the whey protein solution has a conductivity of at most 5 mS/cm. Preferably, the whey protein solution has a conductivity of at most 4 mS/cm.

Lower conductivities are even more preferred and give rise to higher yields of BLG crystals. Thus, the whey protein solution preferably has a conductivity of at most 3 mS/cm. In some preferred embodiments of the invention, the whey protein solution has a conductivity of at most 1 mS/cm. Preferably, the whey protein solution has a conductivity of at most 0.5 mS/cm.

The conductivity of the whey protein feed is preferably reduced by dialysis or diafiltration. Diafiltration by ultrafiltration is particularly preferred as it allows for washing out salts and small charged molecules while proteins are retained. In some preferred embodiments of the invention, the same UF unit is used for UF/diafiltration and subsequent concentration of the whey protein feed.

The present inventors have seen indications that the ratio between the conductivity (expressed in mS/cm) and the total amount of protein in the whey protein solution (expressed in % wt. total protein relative to the total weight of the whey protein solution) advantageously can be kept at or below a certain threshold to facilitate the crystallisation of non-aggregated BLG.

In some preferred embodiments of the invention, the ratio between the conductivity and the total amount of protein of the whey protein solution is at most 0.3. Preferably, the ratio between the conductivity and the total amount of protein of the whey protein solution is at most 0.25. Preferably, the ratio between the conductivity and the total amount of protein of the whey protein solution is at most 0.20. More preferably, the ratio between the conductivity and the total amount of protein of the whey protein solution is at most 0.18. Even more preferably, the ratio between the conductivity and the total amount of protein of the whey protein solution is at most 0.12. Most preferably, the ratio between the conductivity and the total amount of protein of the whey protein solution is at most 0.10.

It is for example preferred that the ratio between the conductivity and the total amount of protein of the whey protein solution is approx. 0.07, or even lower.

The present inventors have furthermore found that the whey protein feed advantageously may be conditioned to provide a whey protein solution having a UF permeate conductivity of at most 10 mS/cm. The UF permeate conductivity is a measure of the conductivity of the small molecule fraction of a liquid. When the term “conductivity” is used herein as such, it refers to the conductivity of the liquid in question. When the term “UF permeate conductivity” is used, it refers to the conductivity of the small molecule fraction of a liquid and is measured according to Example 1.14.

Preferably, the UF permeate conductivity of the whey protein solution is at most 7 mS/cm. More preferably, the UF permeate conductivity of the whey protein solution may be at most 5 mS/cm. Even more preferably, the UF permeate conductivity of the whey protein solution may be at most 3 mS/cm.

Even lower UF permeate conductivities may be used and are particularly preferred if a high yield of non-aggregated BLG should be obtained. Thus, preferably, the UF permeate conductivity of the whey protein solution is at most 1.0 mS/cm. More preferably, the UF permeate conductivity of the whey protein solution may be at most 0.4 mS/cm. Even more preferably, the UF permeate conductivity of the whey protein solution may be at most 0.1 mS/cm. Most preferably, the UF permeate conductivity of the whey protein solution may be at most 0.04 mS/cm.

Even lower UF permeate conductivities may be reached, e.g. if MilliQ water is used as a diluent during diafiltration (MilliQ water has a conductivity of approx. 0.06 μS/cm) Thus, the UF permeate conductivity of the whey protein solution may be at most 0.01 mS/cm. Alternatively, the UF permeate conductivity of the whey protein solution may be at most 0.001 mS/cm. Alternatively, the UF permeate conductivity of the whey protein solution may be at most 0.0001 mS/cm.

In some preferred embodiments of the invention, the preparation of the whey protein solution involves reducing the temperature of the whey protein feed.

For example, the preparation of the whey protein solution may involve reducing the temperature of the whey protein feed to at least 5 degrees C., preferably at least 10 degrees C. and even more preferably at least 15 degrees C. For example, the preparation of the whey protein solution may involve reducing the temperature of the whey protein feed to at least 20 degrees C.

The temperature of the whey protein feed may e.g. be reduced to at most 30 degrees C., preferably at most 20 degrees C., and even more preferably to at most 10 degrees C. The inventors have found that even lower temperatures provide higher degree of supersaturation, and thus, the temperature of the whey protein feed may e.g. be reduced to at most 5 degrees C., preferably at most 2 degrees C., and even more preferably to at most 0 degrees C. The temperature may even be lower than 0 degrees C. However, preferably the whey protein solution should remain pumpable, e.g. in the form of an ice slurry.

In some preferred embodiments of the invention, the whey protein solution is an ice slurry before the initialisation of BLG crystallisation. Alternatively or additionally, crystallising whey protein solution may be converted into or maintained as an ice slurry during the BLG crystallisation of step b).

In some particularly preferred embodiments of the invention, the preparation of the whey protein solution involves increasing the total protein concentration of the whey protein feed. The whey protein feed may e.g. be subjected to one or more protein concentration steps such as ultrafiltration, nanofiltration, reverse osmosis, and/or evaporation and thereby concentrated to obtain the whey protein solution.

Ultrafiltration is particularly preferred as it allows for selective concentration of protein while the concentrations of salts and carbohydrates are nearly unaffected. As mentioned above, ultrafiltration is preferably used both for diafiltration and concentration of the whey protein feed.

In some preferred embodiments of the invention, the concentration of non-aggregated BLG in the whey protein solution is below the level where spontaneous crystallisation of non-aggregated BLG occurs. It is therefore often preferred to stop the modifications of the whey protein feed when the whey protein solution is in the meta-stable region, i.e. in the supersaturated region where BLG crystals can grow when seeding is used but where crystallisation does not start spontaneously.

In some preferred embodiments of the invention, the preparation of the whey protein solution involves addition of one or more water activity reducing agent(s) to the whey protein feed.

Useful, but non-limiting, examples of such water activity reducing agents are polysaccharides and/or poly-ethylene glycol (PEG).

In some preferred embodiments of the invention, the preparation of the whey protein solution involves modifying the ion composition of the whey protein feed, e.g. by ion exchange, by adding new ion species, by dialysis or by diafiltration.

Typically, the whey protein solution is prepared by combining two or more of the above process steps for creating supersaturation.

In some preferred embodiments of the invention, the preparation of the whey protein solution involves subjecting the whey protein feed to at least:
concentration, e.g. using ultrafiltration, nanofiltration or reverse osmosis, at a temperature above 10 degrees C., and
subsequently cooling to a temperature below 10 degrees C.

In other preferred embodiments of the invention, the preparation of the whey protein solution involves subjecting the whey protein feed to at least
concentration at a pH above 6.0, and
subsequently reducing the pH by addition of an acid (e.g. GDL or cation exchange material in H⁺ form)

In yet other preferred embodiments of the invention, the preparation of the whey protein solution involves subjecting the whey protein feed to at least:
reducing the conductivity, e.g. by diafiltration using a membrane that retains at least non-aggregated BLG.

In further preferred embodiments of the invention, the preparation of the whey protein solution involves subjecting the whey protein feed to a combination at least:
adjusting the pH to 5-6,
reducing the conductivity by diafiltration using a membrane that retains at least non-aggregated BLG,
concentrating protein, e.g. using ultrafiltration, nanofiltration or reverse osmosis, at a temperature above 10 degrees C., and
finally, cooling to a temperature below 10 degrees C.

The present inventors have furthermore found that the non-aggregated BLG yield of the present method may be improved by controlling the molar ratio between the sum of sodium+potassium vs. the sum of calcium+magnesium. A higher relative amount of calcium and magnesium surprisingly seems to increase the yield of non-aggregated BLG and therefore increases the efficiency of the non-aggregated BLG recovery of the present method.

In some preferred embodiments of the present invention, the whey protein solution of step a) has a molar ratio between Na+K and Ca+Mg of at most 4. More preferably, the whey protein solution of step a) has a molar ratio between Na+K and Ca+Mg of at most 2. Even more preferably, the whey protein solution of step a) has a molar ratio between Na+K and Ca+Mg of at most 1.5, and even more preferably at most 1.0. Most preferably, the whey protein solution of step a) has a molar ratio between Na+K and Ca+Mg of at most 0.5, such as e.g. at most 0.2.

The molar ratio between Na+K and Ca+Mg it calculated as (m_{Na}+m_{K})/(m_{Ca}+m_{Mg}) wherein m_{Na} is the content of elemental Na in mol, m_{K} is the content of elemental K in mol, m_{Ca} is the content of elemental Ca in mol, and m_{Mg} is the content of elemental Mg in mol.

It is particularly preferred that the whey protein solution has been supersaturated with respect to BLG by salting-in and that non-aggregated BLG therefore can be crystallised from the whey protein solution in salting-in mode.

In some embodiments of the invention, the whey protein solution has a low content of denatured protein. This is particularly preferred to avoid that aggregated BLG ends up in the ALA-enriched whey protein composition. Preferably, the whey protein solution has a degree of protein denaturation of at most 2%, preferably at most 1.5%, more preferably at most 1.0%, and most preferably at most 0.8%.

Step b) of the method involves crystallising at least some of the non-aggregated BLG of the supersaturated whey protein solution.

It is particularly preferred that the crystallisation of step b) takes place in salting-in mode, i.e. in a liquid that has a low ionic strength and conductivity. This is contrary to the salting-out mode, wherein significant amounts of salts are added to a solution in order to provoke crystallisation.

The crystallisation of non-aggregated BLG of step b) may e.g. involve one or more of the following:
Waiting for crystallisation to take place,
Addition of crystallisation seeds,
Increasing the degrees of supersaturation of non-aggregated BLG even further, and/or
Mechanical stimulation.

In some preferred embodiments of the invention, step b) involves adding crystallisation seeds to the whey protein solution. The inventors have found that addition of crystallisation seeds makes it possible to control when and where the BLG crystallisation takes place to avoid sudden clogging of process equipment and unintentional stops during production. It is for example often desirable to avoid onset crystallisation while concentrating the whey protein feed.

It is particularly preferred that the whey protein solution does not contact an UF membrane or MF membrane in operation during step b) unless ceramic membranes or high shear systems, such as DCF, are employed.

In principle, any seed material which initiates the crystallisation of non-aggregated BLG may be used. However, it is preferred that hydrated BLG crystals or dried BLG crystals are used for seeding to avoid adding additional impurities to the whey protein solution.

The crystallisation seeds may be on dry form or may form part of a suspension when added to the whey protein solution. Adding a suspension containing the crystallisation seeds, e.g. BLG crystals, is presently preferred as it appears to provide a faster onset of crystallisation. It is preferred that such a suspension contains crystallisation seeds having a pH in the range of 5-6 and a conductivity of at most 10 mS/cm.

It is particularly preferred that the crystallisation seeds are added via a suspension of BLG crystals that have not been dried after BLG crystallisation. Such a suspension could for example be a portion of BLG crystals and mother liquor obtained from step 2) of a previous batch or portion of wet BLG crystals obtained from step 3), 4) or 5) of a previous batch.

The present inventors have observed that the use of wet BLG crystals for crystallisation seeds provides much larger BLG crystals during step 2) than if dry or poorly hydrated BLG crystals are used, which again makes the separation of BLG from the mother liquor more efficient. In an experiment in which the whey protein feed, crystallisation conditions, mass and particle size of seeding material, cooling profile, and separation method was the same the inventers found that seeding with non-dried BLG crystals provided a 100% increase in the particle size of the obtained crystals (obtained particle size: 100-130 microns) relative to BLG crystals obtained by seeding with rehydrated, dried BLG crystals (obtained particle size: 40-60 microns).

Alternatively, if the crystallisation seeds are based on dried BLG crystals, it is preferred to resuspend the crystals in an aqueous liquid, e.g. water, and allow the dried BLG crystals to rehydrate for at least 30 minutes, preferably at least 1.0 hour, and even more preferably at least 1.5 hours before the resulting BLG crystal suspension is used for initiating crystallisation.

In some embodiments of the invention, at least some of the crystallisation seeds are located on a solid phase which is brought in contact with the whey protein solution.

The crystallisation seeds preferably have a smaller particle size than the desired size of the BLG crystals. The size of the crystallisation seeds may be modified by removing the largest seeds by sieving or other size fractionation processes. Particle size reduction, e.g. by means of grinding, may also be employed prior to the particle size fractionation.

In some embodiments of the invention, at least 90% w/w of the crystallisation seeds have a particle size (measured by sieving analysis) in the range of 0.1-600 microns. For example, at least 90% w/w of the crystallisation seeds may have a particle size in the range of 1-400 microns. Preferably, at least 90% w/w of the crystallisation seeds may have a particle size in the range of 5-200 microns. More preferably, at least 90% w/w of the crystallisation seeds may have a particle size in the range of 5-100 microns.

The particle size and dosage of crystallisation seeds may be tailored to provide the optimal crystallisation of non-aggregated BLG.

In some preferred embodiments of the invention, the crystallisation seeds are added to the whey protein feed prior to obtaining supersaturation with respect to BLG but preferably in a way that at least some crystallisation seeds are still present when supersaturation is reached. This may e.g. be accomplished by adding crystallisation seeds when the whey protein feed is close to supersaturation, e.g. during cooling, concentration, and/or pH adjustment and to reach supersaturation before the crystallisation seeds are completely dissolved.

In some preferred embodiments of the invention, step b) involves increasing the degree of supersaturation of non-aggregated BLG even further, preferably to a degree where crystallisation of BLG initiates immediately, i.e. in at most 20 minutes, and preferably in at most 5 minutes.

This is also referred to as the nucleation zone wherein crystallites form spontaneously and start the crystallisation process.

The degree of supersaturation may e.g. be increased by one or more of the following:
increasing the protein concentration of the whey protein solution further
cooling the whey protein solution further
bringing the whey protein solution closer to the optimum pH for BLG crystallisation
reducing the conductivity even further.

In some preferred embodiments of the invention, step b) involves waiting for the BLG crystals to form. This may take several hours and is typically for a whey protein solution which is only slightly supersaturated with respect to BLG and to which no crystallisation seeds have been added.

In some preferred embodiments of the invention, the provision of the whey protein solution (step a) and the crystallisation of non-aggregated BLG (step b) take place as two separate steps.

However, in other preferred embodiments of the invention, step b) involves additional adjustment of the crystallising whey protein solution to raise the degree of supersaturation of non-aggregated BLG, or at least maintain supersaturation. The additional adjustment results in an increased yield of BLG crystals.

Such additional adjustment may involve one or more of:
increasing the protein concentration of the crystallising whey protein solution even further
cooling the crystallising whey protein solution to an even lower temperature
bringing the crystallising whey protein solution even closer to the optimum pH for BLG crystallisation
reducing the conductivity of the crystallising whey protein solution even further.

In some preferred embodiments of the invention, the crystallising whey protein solution is maintained in the meta-stable zone during step b) to avoid spontaneous formation of new crystallites.

The inventors have determined the crystal lattice structure of the isolated BLG crystals by x-ray crystallography and have not found a similar crystal in the prior art.

In some preferred embodiments of the invention, at least some of the BLG crystals obtained during step b) have an orthorhombic space group P 2₁ 2₁ 2₁.

Preferably, at least some of the obtained BLG crystals have an orthorhombic space group P 2₁ 2₁ 2₁ and the unit cell dimensions a=68.68 (±5%) Å, b=68.68 (±5%) Å, and c=156.65 (±5%) Å; and unit cell integral angles α=90°, β=90°, and γ=90°.

In some preferred embodiments of the invention, at least some of the obtained BLG crystals have an orthorhombic space group P 2₁ 2₁ 2₁ and the unit cell dimensions a=68.68 (±2%) Å, b=68.68 (±2%) Å, and c=156.65 (±2%) Å; and the unit cell integral angles α=90°, β=90°, and γ=90°.

Even more preferred, at least some of the obtained BLG crystals may have an orthorhombic space group P 2₁ 2₁ 2₁ and the unit cell dimensions a=68.68 (±1%) Å, b=68.68 (±1%) Å, and c=156.65 (±1%) Å; and the unit cell integral angles α=90°, β=90°, and γ=90°.

Most preferably, at least some of the obtained BLG crystals have an orthorhombic space group P 2₁ 2₁ 2₁ and the unit cell dimensions a=68.68 Å, b=68.68 Å, and c=156.65 Å; and the unit cell integral angles α=90°, β=90°, and γ=90°.

In some particularly preferred embodiments of the invention, the method contains a step c) of separating at least some of the BLG crystals from the remaining whey protein solution. This is especially preferred when purification of non-aggregated BLG is desired.

Step c) may for example comprise separating the BLG crystals to a solids content of at least 30% w/w. Preferably, step c) comprises separating the BLG crystals to a solids content of at least 40% w/w. Even more preferably, step c) comprises separating the BLG crystals to a solids content of at least 50% w/w.

The inventors have found that the high solids content is advantageous for the purification of non-aggregated BLG, as the aqueous portion that adhere to the separated BLG crystals typically contains the impurities that should be avoided. Additionally, the high solids content reduces the energy consumption for converting the separated BLG crystals to a dry product, such as e.g. a powder, and it increases the non-aggregated BLG yield obtained from a drying unit with a given capacity.

In some preferred embodiments of the invention, step c) comprises separating the BLG crystals to a solids content of at least 60%. Preferably, step c) comprises separating the BLG crystals to a solids content of at least 70%. Even more preferably, step c) comprises separating the BLG crystals to a solids content of at least 80%.

In some preferred embodiments of the invention, the separation of step c) involves one or more of the following operations:
centrifugation,
decantation,
filtration,
sedimentation,
combinations of the above.

These unit operations are well-known to the person skilled in the art and are easily implemented. Separation by filtration may e.g. involve the use of vacuum filtration, dynamic cross-flow filtration (DCF), a filtrate press or a filter centrifuge.

Different pore sizes for filtration may be employed based on the desired outcome. Preferably, the filter allows native whey protein and small aggregates to pass but retains the BLG crystals. The filter preferably has a nominal pore size of at least 0.1 micron. The filter may e.g. have a nominal pore size of at least 0.5 micron. Even more preferably, the filter may have a nominal pore size of at least 2 micron.

Filters having larger pore sizes can also be used and are in fact preferred if primarily the large crystals should be separated from a liquid containing BLG crystals. In some embodiments of the invention, the filter has a nominal pore size of at least 5 micron. Preferably, the filter has a nominal pore size of at least 20 micron. Even more preferably, the filter may have a pore size of at least 40 micron.

The filter may e.g. have a pore size in the range of 0.03-5000 micron, such as e.g. 0.1-5000 micron. Preferably, the filter may have a pore size in the range of 0.5-1000 micron. Even more preferably, the filter may have a pore size in the range of 5-800 micron, such as e.g. in the range of 10-500 micron or in the range of 50-500 microns.

In some preferred embodiments of the invention, the filter has a pore size in the range of 0.03-100 micron. Preferably, the filter may have a pore size in the range of 0.1-50 micron. More preferably, the filter may have a pore size in the range of 4-40 micron. Even more preferably, the filter may have a pore size in the range of 5-30 micron such as in the range of 10-20 micron.

An advantage of using filters having a pore size larger than 1 micron is that bacteria and other microorganisms also are at least partly removed during separation and optionally also during washing and/or recrystallisation.

Another advantage of using filters having a pore size larger than 1 micron is that removal of water and subsequent drying becomes easier and less energy consuming.

The remaining whey protein solution which is separated from the BLG crystals may be recycled to the whey protein feed during preparation of the whey protein solution.

In some preferred embodiments of the invention, step c) employs a filter centrifuge. In other preferred embodiments of the invention, step c) employs a decanter centrifuge. Initial results have shown that use of a filter centrifuge and/or a decanter centrifuge for separating BLG crystals from the mother liquor provides more robust operation of the method than e.g. vacuum filtration.

Often it is preferred to dry a formed filter cake with a drying gas to reduce the moisture content of the filter cake and preferably to make it possible to peel the filter cake off the filter. The use of a drying gas may form part of the separation step or alternatively, the final drying step, if the filter cake is converted directly to a dry edible BLG composition.

In some preferred embodiments of the invention, step c) employs a DCF unit.

Initial tests (see example 6) have shown that using a DCF unit with a membrane pore size in the range of 0.03-5 micron, and preferably in the range of 0.3-1.0 microns, offers an efficient separation of BLG crystals, and the inventors have observed that the DCF unit can be run for a duration sufficient to separate crystals from even large batches of whey protein solution containing BLG crystals.

In some preferred embodiments of the invention step c) is performed using a DCF unit equipped with a membrane capable of retaining BLG crystals, the DCF permeate is recycle to form part of the whey protein solution or whey protein feed, and DCF retentate may be recovered or returned to the crystallisation tank. Preferably, the DCF permeate is treated, e.g. by ultra-/diafiltration to make it supersaturated with respect to BLG prior to mixing with the whey protein solution or whey protein feed.

Advantageously, these embodiments do not require that the temperature of the liquid streams are raised above 15 degrees C. and are therefore less prone to microbial contamination than method variants that require higher temperatures. Another industrial advantage of these embodiments is that the level of supersaturation is easily controlled and can be kept at a level where unwanted, spontaneous crystallisation does not occur. The temperature of the liquid streams during these embodiments of the method is therefore preferably at most 15 degrees C., more preferably at most 12 degrees C., and even more preferably at most 10 degrees C., and most preferably at most 5 degrees C.

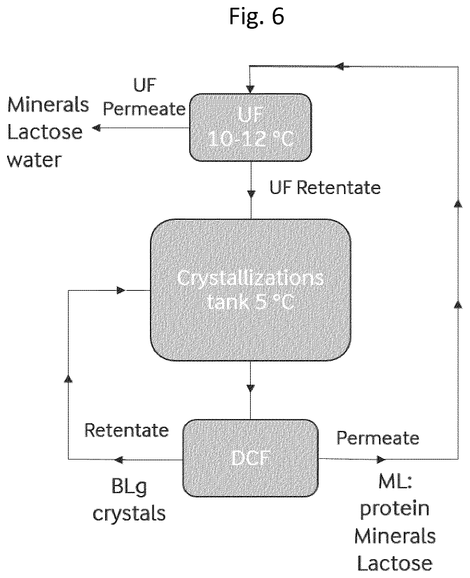

These embodiments are exemplified in Example 6 and illustrated in FIG. 6. These embodiments may be implemented as a batch methods or a continuous method.

In some preferred embodiments of the invention, the method comprises a step of washing BLG crystals, e.g. the separated BLG crystals of c). The washing may consist of a single wash or of multiple washing steps.

The washing preferably involves contacting the BLG crystals with a washing liquid, without completely dissolving the BLG crystals, and subsequently separating the remaining BLG crystals from the washing liquid.

The washing liquid is preferably selected to avoid complete dissolution of the BLG crystals and may e.g. comprise, or even consist essentially of, demineralised water, tap water, or reverse osmosis permeate.

The washing liquid may e.g. comprise, or even consist essentially of, cold demineralised water, cold tap water, or cold reverse osmosis permeate.

The washing liquid may have a pH in the range of 5-6, preferably in the range of 5.0-6.0, and even more preferably in the range of 5.1-6.0, such as e.g. in the range of 5.1-5.9.

Alternatively, the washing liquid may have a pH in the range of 6.1-8, preferably in the range of 6.4-7.6, and even more preferably in the range of 6.6-7.4, such as e.g. in the range of 6.8-7.2. This is typically the pH of the washing liquid when demineralised water, tap water, or reverse osmosis permeate. It is generally preferred that the washing liquid is low in minerals and has a low buffer capacity.

The washing liquid may have a conductivity of at most 0.1 mS/cm, preferably at most 0.02 mS/cm, and even more preferably at most 0.005 mS/cm.

Washing liquids having even lower conductivities may be used. For example, the washing liquid may have a conductivity of at most 1 microS/cm. Alternatively, the washing liquid may have a conductivity of at most 0.1 microS/cm, such as e.g. approx. 0.05 microS/cm.

A washing step is preferably performed at low temperature to limit the dissolution of crystallised BLG. The temperature of the washing liquid is preferably at most 30 degrees C., more preferably at most 20 degrees C. and even more preferably at most 10 degrees C.

A washing step may e.g. be performed at at most 5 degrees C., more preferably at at most 2 degrees C. such as e.g. approx. 0 degrees C. Temperatures lower than 0 degrees C. may be used in so far as the washing liquid does not freeze at that temperature, e.g. due to the presence of one or more freezing point depressant(s).

In some embodiments of the invention, the washing liquid contains non-aggregated BLG, e.g. in an amount of at least 1% w/w, and preferably in an amount of at least 3% w/w, such as e.g. in an amount of 4% w/w.

The washing of step d) typically dissolves at most 80% w/w of the initial amount of BLG crystals, preferably at most 50% w/w, and even more preferably at most 20% w/w of the initial amount of BLG crystals. Preferably, the washing of step d) dissolves at most 15% w/w of the initial amount of BLG crystals, more preferably at most 10% w/w, and even more preferably at most 5% w/w of the initial amount of BLG crystals.

The weight ratio between the total amount of washing liquid and the initial amount of separated BLG crystals is often at least 1, preferably at least 2 and more preferably at least 5. For example, the weight ratio between the amount of washing liquid and the initial amount of separated BLG crystals may be at least 10. Alternatively, the weight ratio between the amount total of washing liquid and the initial amount of separated BLG crystals may be at least 20, such as e.g. at least 50 or at least 100.

The term “total amount of washing liquid” pertains to the total amount of washing liquid used during the entire process.

In some preferred embodiments of the invention, the one or more washing sequences take place in the same filter arrangement or in a similar filter arrangement as the BLG crystal separation. A filter cake primarily containing BLG crystals is added one or more sequences of washing liquid which is removed through the filter while the remaining part of the BLG crystals stays in the filter cake.

In particularly preferred embodiments of the invention, the separation of step c) is performed using a filter that retains BLG crystals. Subsequently, the filter cake is contacted with one or more quantities of washing liquid which moves through the filter cake and the filter. It is often preferred that each quantity of washing liquid is at most 10 times the volume of the filter cake, preferably at most 5 times the volume of the filter cake, more preferably at most 1 times the volume of the filter cake, even more preferably at most 0.5 times the volume of the filter cake, such as e.g. at most 0.2 times the volume of the filter cake. The volume of the filter cake includes both solids and fluids (liquids and gasses) of the filter cake. The filter cake is preferably washed this way at least 2 times, preferably at least 4 times and even more preferably at least 6 times.

The used washing liquid from the washing step may e.g. be recycled to the whey protein feed or the whey protein solution where washed out non-aggregated BLG may be isolated again. The method may furthermore comprise a step which involves a recrystallisation step comprising:
dissolving the separated BLG crystals in a recrystallisation liquid,
adjusting the recrystallisation liquid to obtain supersaturation with respect to BLG,
crystallising non-aggregated BLG in the supersaturated, adjusted recrystallisation liquid, and
separating BLG crystals from the remaining adjusted recrystallisation liquid.

The recrystallisation may comprise either a single recrystallisation sequence or multiple recrystallisation sequences.

In some embodiments of the invention, the BLG crystals of step or c) or subsequently washed BLG crystals are recrystallised at least 2 times. For example, the BLG crystals may be recrystallised at least 3 times, such as e.g. at least 4 times.

The washing and recrystallisation steps may be combined in any sequence and may be performed multiple times if required.

The separated BLG crystals of step c) may e.g. be subjected to the process sequence:
One or more steps of washing, followed by
One or more steps of recrystallisation.

Alternatively, the separated BLG crystals of step c) may be subjected to the process sequence:
One or more steps of recrystallisation, followed by
One or more steps of washing.

It is also possible to combine multiple steps of washing and recrystallisation, e.g. in the sequence:
One or more steps of washing,
One or more steps of recrystallisation,
One or more steps of washing, and
One or more steps of recrystallisation.

Or e.g. in the sequence:
One or more steps of recrystallisation,
One or more steps of washing,
One or more steps of recrystallisation.
One or more steps of washing

Step d) provides a first composition derived from the recovered mother liquor.

In the context of the present invention, the terms “first composition derived from the recovered mother liquor” and “first composition” pertain to a aqueous, liquid composition that comprises at least a significant amount of the ALA of the recovered mother liquor and preferably substantially all ALA of the recovered mother liquor.

In some embodiments of the invention, the first composition comprises at least 20% of the ALA of the recovered mother liquor, preferably at least 40%, more preferably at least 60%, even more preferably at least 80% and most preferably at least 90% of the ALA of the recovered mother liquor. Preferably, the first composition comprises substantially all ALA of the recovered mother liquor.

In other preferred embodiments of the invention, the first composition comprises or even consists of the recovered mother liquor. Thus, it may be preferred that the first composition is the recovered mother liquor as such.

In other preferred embodiments of the invention, the first composition is a protein concentrate of the recovered mother liquor.

In some embodiments of the invention, it is furthermore possible that the first composition comprises one or more additional whey protein sources, and it is often preferred that the weight percentage of ALA relative to total protein of the first composition is at least the same as in the recovered mother liquor.

If the recovered mother liquor does not already have the required characteristics, provision of the first composition may e.g. involve subjecting the recovered mother liquor to one or more steps selected from the group of:
demineralisation,
addition of minerals
dilution,
concentration,
physical microbial reduction, and
pH adjustment.

Non-limiting examples of demineralisation include e.g. dialysis, gel filtration, UF/diafiltration, NF/diafiltration, and ion exchange chromatography.

Non-limiting examples of addition of minerals include addition of soluble, food acceptable salts, such as e.g. salts of Na, K, Ca, and/or Mg. Such salt may e.g. by phosphate salts, chloride salts or salts of food acids, such as e.g. citrate, lactobioinate or lactate salts. The minerals may be added in solid, suspended, or dissolved form.

Non-limiting examples of dilution include e.g. addition of liquid diluent such as water, demineralised water, or aqueous solutions of minerals, acids or bases.

Non-limiting examples of concentration include e.g. evaporation, reverse osmosis, nanofiltration, ultrafiltration and combinations thereof.

If the concentration has to increase the concentration of protein relative to total solids, it is preferred to use concentration steps such as ultrafiltration or alternatively dialysis. If the concentration does not have to increase the concentration of protein relative to total solids, methods such as e.g. evaporation, nanofiltration and/or reverse osmosis can be useful.

Non-limiting examples of physical microbial reduction include e.g. heat-treatment, germ filtration, UV radiation, high pressure treatment, pulsed light treatment, pulsed electric field treatment, and ultrasound. These methods are well-known to the person skilled in the art.

Germ filtration typically involves microfiltration or large pore ultrafiltration and requires a pore size that is capable of retaining microorganisms but allow the proteins and other components of interest to pass. Useful pore sizes are typically at most 1.5 micron, preferably at most 1.0 micron, more preferably at most 0.8 micron, even more preferably at most 0.5 micron, and most preferably at most 0.2 micron. The pore size for germ filtration is normally at least 0.1 micron.

The germ filtration may for example involve a membrane having a pore size of 0.02-1 micron, preferably 0.03-0.8 micron, more preferably 0.04-0.6 micron, even more preferably 0.05-0.4 micron, and most preferably 0.1-0.2 micron.

In some preferred embodiments of the invention the liquid to be treated, preferably the mother liquor, is subjected to a germ filtration and subsequently to the heat-treatment using a temperature of at most 80 degrees C., and preferably at most 75 degrees C. The combination of temperature and duration of this heat-treatment of preferably chosen to provide a sterile liquid.

In other preferred embodiments of the invention the liquid to be treated, preferably the mother liquor, is subjected to a germ filtration and subsequently to the heat-treatment using a temperature of at least 150 degrees C. for a duration of at most 0.2 seconds, and preferably at most 0.1 seconds. The combination of temperature and duration of this heat-treatment of preferably chosen to provide a sterile liquid.

In some preferred embodiments of the invention, the physical microbial reduction involves or even consists of heat-treatment.

Preferably, the heat-treatment involves at least pasteurisation.

In particularly preferred embodiments, heat-treatment involves heating to a temperature in the range of 70-80 degrees C.

In some preferred embodiments of the invention, the temperature of the heat-treatment is in the range 70-80 degrees C., preferably in the range 70-79 degrees C., more preferably in the range 71-78 degrees C., even more preferably in the range 72-77 degrees C., and most preferably in the range 73-76 degrees C., such as approx. 75 degrees C.

Preferably, the duration of the heat-treatment, when performed in the temperature range 70-80, is 1 second to 30 minutes. The highest exposure times are best suited for the lowest temperatures of the temperature range and vice versa.

In particularly preferred embodiments of the invention, the heat-treatment provides 70-78 degrees C. for 1 second to 30 minutes, more preferably 71-77 degrees C. for 1 minute to 25 minutes, and even more preferred 72-76 degrees C. for 2 minute to 20 minutes.

Higher temperatures may also be preferred in some embodiments, especially if unfolding and optionally also aggregation of non-aggregated BLG is required prior to drying. For example, the temperature of the heat-treatment may be at least 81 degrees C., preferably at least 91 degrees C., more preferably at least 100 degrees C., even more preferably at least 120 degrees C., and most preferably at least 140 degrees C.

The heat-treatment may for example involve a temperature in the range of 90-130 degrees C. and a duration in the range of 4 seconds-30 minutes. The heat-treatment may e.g. involve heating to a temperature in the range of 90-95 degrees C. for a duration of 1-10 minutes, e.g. approx. 120 degrees C. for 20 approx. seconds. Alternatively, the heat-treatment may involve heating to a temperature in the range of 115-125 degrees C. for a duration of 5-30 seconds, e.g. approx. 120 degrees C. for 20 approx. seconds.

Alternatively, the heat-treatment may for example be a UHT-type treatment which typically involves a temperature in the range of 135-144 degrees C. and a duration in the range of 2-10 seconds.

Alternatively, but also preferred, the heat-treatment may involve a temperature in the range of 145-180 degrees C. and a duration in the range of 0.01-2 seconds, and more preferably a temperature in the range of 150-180 degrees C. and a duration in the range of 0.01-0.3 seconds.

The implementation of the heat-treatment may involve the use of conventional equipment such as a plate or tubular heat exchanger, scraped surface heat exchanger or a retort system. Alternatively, and particularly preferred for heat-treatments above 95 degrees C., direct steam-based heating may be employed, e.g. using direct steam injection, direct steam infusion, or spray-cooking. Additionally, such direct steam-based heating is preferably used in combination with flash cooling. Suitable examples of implementation of spray-cooking are found in WO2009113858A1, which are incorporated herein for all purposes. Suitable examples of implementation of direct steam injection and direct steam infusion are found in WO2009113858A1 and WO 2010/085957 A3, which are incorporated herein for all purposes. General aspects of high temperature treatment are e.g. found in “Thermal technologies in food processing” ISBN 185573558 X, which is incorporated herein by reference for all purposes.

Non-limiting examples of pH adjustment include e.g. addition of bases and/or acids, and preferably food acceptable bases and/or acids. It is particularly preferred to employ acids and/or bases that are capable of chelating divalent metal cations. Examples of such acids bases are EDTA, citric acid, citrate salts, lactobionic acid, lactobionate salt, gluconic acid, gluconate salts, lactic acids, lactate salt, phosphoric acid, phosphate salt and combinations thereof.

In some preferred embodiments of the invention, the pH of the first composition has substantially the same pH as the mother liquor, thus preferably in the range of pH 5-6. Alternatively, the first composition may have a pH outside the pH-range 5-6.

Initial experiments performed by the inventors have revealed that the recovered mother liquor often is capable of continued BLG crystallisation if it e.g. is concentrated more or cooled to a lower temperature. The present inventors believe that the recovered mother liquor still contains small crystal fragments that has escaped the separation of step c) and therefore is already seeded for crystallisation. Liquids are typically concentrated prior to drying in order to reduce the amount of energy required for drying but this concentration can provoke the formation of unwanted BLG crystals if the recovered mother liquor is used as such. The inventors have found that it is advantageous to bring the non-aggregated BLG level of the recovered mother liquor below the level of supersaturation before drying the product or before concentrating it to avoid undesired crystallisation and fouling in the production.

Thus, in some preferred embodiments of the invention, the first composition or protein concentrate of the first composition is not supersaturated with respect to BLG. Alternatively the first composition or protein concentrate of the first composition may be supersaturated with respect to BLG as long as it does not contain BLG crystals.

The pH-adjustment of step e) ensures that the first composition or protein concentrate of the first composition is not supersaturated. If the pH of the first composition or a protein concentrate thereof has a pH in the range of 5.0-6.0 it is preferred that the non-aggregated BLG concentration, the conductivity, and/or the temperature is selected to avoid supersaturation.

In yet other preferred embodiments of the invention, the first composition is an ALA isolate of the recovered mother liquor. If so, the provision of the first composition comprises further ALA-enrichment of the recovered mother liquor.

In the context of the present invention the term “further ALA-enrichment” means that the provision of the first composition has involves one or more process steps, i.e. the further ALA-enrichment, which have provided a first composition having a weight percentage of ALA relative to total protein that is at least 5% higher than that of the recovered mother liquor.

Thus, the first composition may e.g. have a weight percentage of ALA relative to total protein that is at least 5% higher than that of the recovered mother liquor. Preferably, the first composition has a weight percentage of ALA relative to total protein that is at least 10% higher than that of the recovered mother liquor, more preferably at least 20% higher, even more preferred at least 30% higher and most preferred at least 50% higher.

Even higher levels of ALA enrichment maybe desired, and in some preferred embodiments of the invention, the first composition has a weight percentage of ALA relative to total protein that is at least 75% higher than that of the recovered mother liquor. Preferably, the first composition has a weight percentage of ALA relative to total protein that is at least 100% higher than that of the recovered mother liquor, more preferably at least 150% higher, even more preferred at least 200% higher and most preferred at least 400% higher.

The weight percentage of ALA of the first composition depends on how the mother liquor has been processed to obtain the first composition, but is typically at least 20% w/w relative to total protein. Preferably, the first composition has a weight percentage of ALA of at least 25% w/w relative to total protein. More preferably, the first composition has a weight percentage of ALA of at least 30% w/w relative to total protein. Even more preferably, the first composition has a weight percentage of ALA of at least 40% w/w relative to total protein. Most preferably, the first composition has a weight percentage of ALA of at least 50% w/w relative to total protein.

The present inventors have estimated that a weight percentage of ALA of more than 60% relative to total protein can be obtained if the whey protein feed is a CMP-free whey protein source such as whey protein isolate from acid whey or milk serum protein isolate and if DCF is used as outlined in Example 5.

Thus, in some preferred embodiments of the invention, the first composition has a weight percentage of ALA of at least 60% w/w relative to total protein. More preferably, the first composition has a weight percentage of ALA of at least 70% w/w. Even more preferably, the first composition has a weight percentage of ALA of at least 80% w/w relative to total protein. Most preferably, the first composition has a weight percentage of ALA of at least 90% w/w relative to total protein.

The further enrichment of ALA may be accomplished by any suitable method.

In some preferred embodiments of the invention, the further enrichment of ALA involves type A enrichment, which involves adjustment of the pH to 3.5-5.5 and heating to 50-70 degrees C. in order to form reversible aggregation of ALA and subsequently recover the aggregated ALA. The ALA recovered by this process will then form part of the first composition. Useful examples of such processes for further ALA enrichment are described in U.S. Pat. No. 5,455,331 (by Pearce et al), U.S. Pat. No. 6,613,377 and Muller et al (Lait 83, pages 439-451, 2003), which all are incorporated herein by reference for all purposes.

In some preferred embodiments of the invention, the further enrichment of ALA involves type B enrichment, which involves subjecting the recovered mother liquor to ion exchange chromatography. Useful examples of such processes for further ALA enrichment are described in de Jongh et al (Mild Isolation Procedure Discloses New Protein Structural Properties of β-Lactoglobulin, J Dairy Sci., vol. 84(3), 2001, pages 562-571) and Vyas et al (Scale-Up of Native β-Lactoglobulin Affinity Separation Process, J. Dairy Sci. 85:1639-1645, 2002), which are incorporated herein by reference for all purposes.

In some preferred embodiments of the invention, the further enrichment of ALA involves type C enrichment using membrane separation to separate ALA from the other whey proteins. A useful example of such a process for further ALA enrichment is described in U.S. Pat. No. 5,008,376, which are incorporated herein by reference for all purposes.

In some preferred embodiments of the invention, the further enrichment of ALA involves type D enrichment using ultrafiltration at a pH of at most pH 4 to remove CMP from ALA and other whey proteins. Useful embodiments and examples of the acidic ultrafiltration steps are described in WO2014076252 A1, WO9929183 A1, and U.S. Pat. No. 5,278,288, all of which are incorporated herein by reference for all purposes.

The further enrichment of ALA may for example involve a combination of two or more of enrichment processes selected from the group consisting of Type A, Type B, Type C, and type D.

In some preferred embodiments of the invention, the first composition comprises ALA in an amount of at least 92% w/w relative to total protein, preferably at least 95% w/w, more preferably at least 97% w/w, even more preferably at least 98%, and most preferably non-aggregated BLG in an amount of at least 99.5% w/w relative to total protein.

In some preferred embodiments of the invention, the first composition comprises total protein in an amount of at least 5% w/w, preferably at least 10% w/w, more preferably at least 15% w/w, even more preferably at least 20%, and most preferably total protein in an amount of at least 30% w/w.

In some preferred embodiments of the invention, the first composition comprises total protein in an amount in the range of 5-40% w/w, preferably in the range of 10-35% w/w, more preferably in the range of 15-30% w/w, even more preferably in the range of 20-25% w/w.

The present inventors have observed that an increasing protein concentration in the first composition gives rise to spray-dried powders having a higher bulk density, and it is therefore preferred to have a relatively high concentration of protein in the first composition.

Thus, in other preferred embodiments of the invention, the first composition comprises total protein in an amount in the range of 10-40% w/w, preferably in the range of 20-38% w/w, more preferably in the range of 24-36% w/w, even more preferably in the range of 28-34% w/w.

In some preferred embodiments of the invention, the first composition comprises a total solids content in an amount in the range of 5-50% w/w, preferably in the range of 10-40% w/w, more preferably in the range of 15-35% w/w, even more preferably in the range of 20-30% w/w.

In some preferred embodiments of the invention, the first composition comprises a water content in an amount in the range of 50-95% w/w, preferably in the range of 60-90% w/w, more preferably in the range of 65-85% w/w, even more preferably in the range of 70-80% w/w.

In some preferred embodiments of the invention, the first composition comprises carbohydrate in an amount of at most 60% w/w, preferably at most 50% w/w, more preferably at most 20% w/w, even more preferably at most 10% w/w, even more preferably at most 1% w/w, and most preferably at most 0.1%. The first composition may for example contain carbohydrates, such as e.g. lactose, oligosaccharides and/or hydrolysis products of lactose (i.e. glucose and galactose), sucrose, and/or maltodextrin.

In some preferred embodiments of the invention, the first composition comprises lipid in an amount of at most 10% w/w, preferably at most 5% w/w, more preferably at most 2% w/w, and even more preferably at most 0.1% w/w.

The present inventors have found that it can be advantageous to control the mineral content to reach some of the desired properties of the first composition.

In some preferred embodiments of the invention, the sum of the amounts of Na, K, Mg, and Ca of the first composition is at most 10 mmol/g protein. Preferably, the sum of the amounts of Na, K, Mg, and Ca of the first composition is at most 6 mmol/g protein, more preferably at most 4 mmol/g protein, even more preferably at most 2 mmol/g protein.

In other preferred embodiments of the invention, the sum of the amounts of Na, K, Mg, and Ca of the first composition is at most 1.0 mmol/g protein. Preferably, the sum of the amounts of Na, K, Mg, and Ca of the first composition is at most 0.6 mmol/g protein, more preferably at most 0.4 mmol/g protein, even more preferably at most 0.2 mmol/g protein, and most preferably at most 0.1 mmol/g protein.

In other preferred embodiments of the invention, the sum of the amounts of Mg and Ca of the first composition is at most 5 mmol/g protein. Preferably, the sum of the amounts of Mg and Ca of the first composition is at most 3 mmol/g protein, more preferably at most 1.0 mmol/g protein, even more preferably at most 0.5 mmol/g protein.

In other preferred embodiments of the invention, the sum of the amounts of Mg and Ca of the first composition is at most 0.3 mmol/g protein. Preferably, the sum of the amounts of Mg and Ca of the first composition is at most 0.2 mmol/g protein, more preferably at most 0.1 mmol/g protein, even more preferably at most 0.03 mmol/g protein, and most preferably at most 0.01 mmol/g protein.

For some applications it is required to modify the pH of the first composition to obtain a product that has the appropriate characteristics. In such embodiments, the method of the invention comprises step e).

Thus, in some preferred embodiments of the invention, the method comprises step e) wherein:
the pH of the first composition is adjusted to a pH in the range of 2.5-4.9, preferably 2.8-4.5 and more preferably 2.8-3.2, or
the pH of the first composition is adjusted to a pH in the range of 6.1-8.5, preferably 6.3-8.0, and even more preferably 6.5-7.5.

For example, the pH of the first composition may be adjusted to a pH in the range of 2.5-4.9, preferably 2.8-4.5 and more preferably 2.8-3.2.

Alternatively, the pH of the first composition may be adjusted to a pH in the range of 6.1-8.5, preferably 6.3-8.0, and even more preferably 6.5-7.5.

The pH adjustment is preferably performed with one or more of the food-grade acids and bases mentioned herein and preferably with dilute acids or dilute bases if strong acids or bases are used.

Step f) involves drying:
the first composition obtained from step d) or a protein concentrate thereof, or
the pH-adjusted first composition obtained from step e) or a protein concentrate thereof.

The drying of step f) typically involves spray drying or freeze drying.

In some preferred embodiments of the invention, the liquid stream subjected to drying is a protein concentrate of the pH-adjusted first composition.

The term “liquid stream subjected to drying” pertains to one of the following liquids:
the first composition obtained from step d)
a protein concentrate of the first composition obtained from step d),
the pH-adjusted first composition obtained from step e), or
a protein concentrate of the pH-adjusted first composition obtained from step e).

In other preferred embodiments of the invention, the liquid stream subjected to drying is a protein concentrate of the first composition.

Spray drying is the presently preferred drying method.

In some embodiments of the invention, the liquid stream subjected to drying has a temperature of at most 70 degrees C. when reaching the exit of the spray device (e.g. a nozzle or an atomizer), preferably at most 60 degrees C., more preferably at most 50 degrees C. In some preferred embodiments of the invention, the liquid stream subjected to drying has a temperature of at most 40 degrees C. when reaching the exit of the spray-device, preferably at most 30 degrees C., more preferably at most 20 degrees C., even more preferably at most 10 degrees C., and most preferably at most 5 degrees C.

The spray-device of the spray drier is the device, e.g. the nozzle or the atomizer, which converts the solution or suspension to be dried into droplets that enter the drying chamber of the spray drier.

It is particularly preferred that the liquid stream subjected to drying has a temperature in the range of 0-50 degrees C. when reaching the exit of the spray-device, preferably in the range of 2-40 degrees C., more preferably in the range of 4-35 degrees C., and most preferably in the range of 5-10 degrees C. when reaching the exit of the spray-device.

The inlet temperature of gas of the spray drier is preferably in the range of 140-220 degrees C., more preferably in the range of 160-200 degrees C., and even more preferably in the range of 170-190 degrees C., such as e.g. preferably approximately 180 degrees C. The exit temperature of the gas from the spray drier is preferably in the range of 50-95 degrees C., more preferably in the range of 70-90 degrees C., and even more preferably in the range of 80-88 degrees C., such as e.g. preferably approximately 85 degrees C. As a rule of thumb, the solids that are subjected to spray drying are said to be heated to a temperature which is 10-15 degrees C. less than the gas exit temperature.

In some preferred embodiments of the invention, the spray drier is preferably in the range of 50-85 degrees C., more preferably in the range of 60-80 degrees C., and even more preferably in the range of 65-75 degrees C., such as e.g. preferably approximately 70 degrees C.

The drying step may furthermore involve fluid bed drying, e.g. integrated in the spray-drying device or as a separate unit operation performed after the spray-drying.

The combination of spray-drying and fluid bed drying makes it possible to reduce the amount of water that is removed while the droplet of liquid to be dried moves the spray-drying chamber and instead removes residual water from the moist powder by fluid bed drying. This solution requires less energy for drying than drying by spray-drying alone and furthermore makes it possible to modify the powder by e.g. instantization and/or agglomeration. Instantization is preferably performed by applying lecithin or another useful wetting agent to the surface of the powder. When instantization is applied the instantisation agent, e.g. lecithin dissolved in an edible oil, is typically added in an amount in the range of 0.5-2% w/w relative to the total final powder weight, and preferably in the range of 1.0-1.5% w/w relative to the total final powder weight.

The present inventors have noticed that the crystallisation process including the preparation of the whey protein solution is prone to microbial growth and have found it advantageous to modify the process to address this problem.

It is particularly preferred that the total amount of time that an ALA molecule is at a temperature above 12 degrees C. from the provision of whey protein feed to the drying of step f) or the subsequent use of ALA for food production is at most 24 hours, preferably 20 hours, more preferred at most 12, even more preferably at most 6 hours, and most preferably at most at most 3 hours.

It is possible and often preferably to reduce the duration even further, and thus, in some preferred embodiments of the invention, the total amount of time that an ALA molecule is at a temperature above 12 degrees C. from the provision of whey protein feed to the drying of step f) or the subsequent use of the first composition for food production is at most 2 hours, preferably 1 hour, more preferably at most 0.5, even more preferably at most 0.3 hours, and most preferably at most at most 0.1 hours.

It is furthermore preferred that the method includes at least one physical microbial reduction, preferably applied to the mother liquor after the removal of BLG crystals and/or applied to a liquid ALA-contain streams following step c).

Physical microbial reduction preferably involves one or more of:
heat-treatment, preferably at least pasteurisation,
UV radiation treatment,
pulsed light treatment,
pulsed electric field treatment,
microfiltration,
high pressure treatment, and
ultrasound treatment.

These processes are well-known to the person skilled in the art and further details regarding heat-treatment have been provided herein.

Physical microbial reduction which involves microfiltration requires a pore size that is capable of retaining microorganisms but allow the proteins and other components of interest to pass. Useful pore sizes are typically at most 1.5 micron, preferably at most 1.0 micron, more preferably at most 0.8 micron, even more preferably at most 0.5 micron, and most preferably at most 0.2 micron. The pore size for germ filtration is normally at least 0.1 micron.

The liquid stream subjected to drying preferably has a low content of microorganisms. In some embodiments of the invention, the liquid stream subjected to drying contains at most 500.000 CFU/g, preferably at most 100.000 CFU/g, more preferably at most 50.000 CFU/g, even more preferably at most 10.000 CFU/g.

Preferably, the liquid stream subjected to drying may contain at most 1000 colony-forming units (CFU)/g. Even more preferably, the liquid stream subjected to drying contains at most 600 CFU/g. More preferably, the liquid stream subjected to drying contains at most 300 CFU/g. Even more preferably, the liquid stream subjected to drying contains at most 100 CFU/g. Even more preferably, the liquid stream subjected to drying contains at most 50 CFU/g. Most preferably, the liquid stream subjected to drying contains at most 20 CFU/gm, such as e.g. at most 10 CFU/g. In a particularly preferred embodiment, the liquid stream subjected to drying is sterile. A liquid stream subjected to drying may e.g. be prepared by combining several physical microbial reduction processes during the liquid stream subjected to drying.

The method often comprises a step of packaging the edible ALA-enriched whey protein composition. The edible whey protein composition is typically packaged in suitable containers which are subsequently closed and/or sealed. The packaging may e.g. be performed under aseptic or sterile conditions and may e.g. involve filling and sealing the edible whey protein composition into sterile containers.

Another aspect of the invention pertains to an edible ALA-enriched whey protein composition, e.g. obtainable by the method defined herein.

In some preferred embodiments of the invention, the edible ALA-enriched whey protein composition comprises:
ALA in an amount in the range of 24-80% w/w, preferably 24-70% w/w relative to total protein,
immunoglobulin in an amount in the range of 3-14% w/w relative to total protein, and
optionally, phospholipid in an amount in the range of 1-6% w/w relative to total protein, preferably in the range of 2-5% w/w relative to total protein.

The amount of phospholipid is measured according to Vaghela et al (Vaghela et al, Quantitative analysis of phospholipids from whey protein concentrates by high-performance liquid chromatography with a narrow-bore column and an evaporative light-scattering detector, Journal of the American Oil Chemists' Society, June 1995, Volume 72, Issue 6, pp 729-733).

Such an edible ALA-enriched whey protein composition is e.g. obtainable when the whey protein feed is a serum protein concentrate which has not been subjected to protein-denaturing heat-treatment.

The inventors have found it particularly advantageous to be able to provide edible ALA-enriched whey protein composition that contain immunoglobulin in addition to ALA and optionally also phospholipid as these components are useful for paediatric nutrition.

In some embodiments of the invention the edible ALA-enriched whey protein composition comprises at most 15% w/w casein species relative to total protein.

In some preferred embodiments of the invention, the ALA-enriched whey protein composition may comprise:
in the range of 40-70% w/w ALA relative to total protein,
at most 15% w/w casein species relative to total protein, and
at least 3% w/w immunoglobulin relative to total protein.

An advantage of the present invention is that the obtained ALA-enriched whey protein composition typically has been treated very gently and has not been subjected to excessive heat-stress. In some preferred embodiments of the invention, the ALA-enriched whey protein composition has a furosine value of at most 50 mg/100 g protein. Preferably, the ALA-enriched whey protein composition has a furosine value of at most 30 mg/100 g protein. More preferably, the ALA-enriched whey protein composition has a furosine value of at most 20 mg/100 g protein. Even more preferably, the ALA-enriched whey protein composition has a furosine value of at most 10 mg/100 g protein. Most preferably, the ALA-enriched whey protein composition has a furosine value of at most 2 mg/100 g protein, and preferably no detectable furosine value at all.

The content of BLG in the ALA-enriched whey protein composition is often relatively low. In some preferred embodiments of the invention, the ALA-enriched whey protein composition comprises at most 40% w/w BLG relative to total protein. Preferably, the ALA-enriched whey protein composition comprises at most 30% w/w BLG relative to total protein. More preferably, the ALA-enriched whey protein composition comprises at most 20% w/w BLG relative to total protein. Even more preferably, the ALA-enriched whey protein composition comprises at most 10% w/w BLG relative to total protein. Most preferably, the ALA-enriched whey protein composition comprises at most 2% w/w BLG relative to total protein. For example, it is preferred that the ALA-enriched whey protein composition comprises at most 0.5% w/w BLG relative to total protein.

Another aspect of the invention pertains to a method of producing a food product, the method comprising the steps of
a) providing a whey protein solution comprising non-aggregated BLG, ALA, and optionally additional whey protein, said whey protein solution is supersaturated with respect to BLG and has a pH in the range of 5-6,
b) crystallising non-aggregated BLG in the supersaturated whey protein solution, preferably in salting-in mode, and
c) separating the BLG crystals from the remaining mother liquor and recovering at least some of the mother liquor,
d) providing a first composition derived from the recovered mother liquor and optionally also the used washing liquid,
e) optionally, adjusting the pH of the first composition to
   i) a pH in the range of 2.5-4.9, or
   ii) a pH in the range of 6.1-8.5,
f) optionally, drying the first composition obtained from step d) or a protein concentrate thereof or drying the pH-adjusted first composition first composition obtained from step e) or a protein concentrate thereof,
g) combining:
   g1) a first composition obtained from step d) or a protein concentrate thereof,
   g2) a pH-adjusted first composition obtained from step e) or a protein concentrate thereof, and/or
   g3) the dried composition obtained from step f) with one or more ingredients and converting the combination to a food product.

The food product is an infant formula, a beverage, an instant beverage powder, a protein bar, porridge, or a smoothie.

The one or more ingredients for preparing the food product often contains one or more nondairy carbohydrates, non-dairy lipids, and/or non-dairy protein. By the term “non-dairy carbohydrate” is meant a carbohydrate that is not present in bovine milk. By the term “non-dairy lipid” is meant a lipid that is not present in bovine milk. By the term “non-dairy carbohydrate” is meant a protein that is not present in bovine milk.

The amino acid profile of the ALA-enriched whey protein composition is particularly well-suited for infant formulas and other paediatric food products.

Yet an aspect of the invention pertains to food product, preferably a nutritional product, comprising the ALA-enriched whey protein composition, e.g. obtainable by the above-mentioned method.

A further aspect of the invention pertains to a nutritional product comprising the ALA-enriched whey protein composition as defined herein.

In the context of the present invention, the term “nutritional product” pertains to an edible product, i.e. safe for human consumption that comprises at least protein and one or more of the following: lipid, carbohydrate, mineral, and vitamin. The nutritional product preferably comprises protein, carbohydrate and lipid, and even more preferred it comprises protein, carbohydrate, lipid, mineral and vitamin.

In some preferred embodiments of the invention, the nutritional product is a nutritional product suitable for clinical nutrition, a nutritional product suitable for sports nutrition or a nutritional product suitable for paediatric nutrition.

It is particularly preferred that the nutritional product is a paediatric nutritional product. Preferably the nutritional product is a nutritionally complete infant formula or an infant formula base which contains at least the protein required for an infant formula. Alternatively, but also preferred, the paediatric nutritional product may be a follow-on formula or a growing-up milk.

In some preferred embodiments of the invention, the nutritional product, e.g. in the form of an infant formula, comprises:
at least 40% w/w ALA relative to the total amount of protein, preferably at least 45% w/w, and
at least 5% w/w immunoglobulin relative to the total amount of protein.

In other embodiments of the invention, the nutritional product, e.g. in the form of an infant formula, comprises:
in the range of 40-70% w/w ALA relative to total protein
at most 15% w/w casein species relative to total protein
and at least 5% w/w immunoglobulin.

In some preferred embodiments of the invention, the nutritional product, e.g. in the form of an infant formula, comprises:
ALA in an amount in the range of 24-80% w/w relative to total protein, preferably 40-70% w/w relative to total protein, and more preferably 45-65% w/w relative to total protein,
immunoglobulin in an amount in the range of 5-14% w/w relative to total protein, and
optionally, phospholipid in an amount in the range of 1-6% w/w relative to total protein, preferably in the range of 2-5% w/w relative to total protein.

In some embodiments of the invention the nutritional product, e.g. in the form of an infant formula, comprises at most 50% w/w casein species relative to total protein, preferably at most 40% w/w casein species relative to total protein, and most 30% w/w casein species relative to total protein.

In some preferred embodiments of the invention, the nutritional product, e.g. in the form of an infant formula, comprises:
in the range of 24-50% w/w ALA relative to total protein,
in the range of 20-40% w/w casein species relative to total protein, and
at least 3-15% w/w immunoglobulin relative to total protein.

The content of BLG of the nutritional product, e.g. in the form of an infant formula, is often relatively low. In some preferred embodiments of the invention, the nutritional product, e.g. in the form of an infant formula, comprises at most 40% w/w BLG relative to total protein. Preferably, the ALA-enriched whey protein composition comprises at most 30% w/w BLG relative to total protein. More preferably, the nutritional product, e.g. in the form of an infant formula, comprises at most 20% w/w BLG relative to total protein. Even more preferably, the nutritional product, e.g. in the form of an infant formula, comprises at most 10% w/w BLG relative to total protein.

Most preferably, the nutritional product, e.g. in the form of an infant formula, comprises at most 2% w/w BLG relative to total protein. For example, it is preferred that the nutritional product, e.g. in the form of an infant formula, comprises at most 0.5% w/w BLG relative to total protein.

The one or more additional ingredients which may be included into the nutritional product may advantageously be selected amongst the ingredients that typically are used in peadiatric products.

For example, the nutritional product, e.g. in the form of an infant formula, may include at least one of the human milk oligosaccharides (HMOs), such as e.g. 2′-FL and LNnT. Research has shown multiple roles for HMOs in improvement of central nervous system (CNS) function. In addition to including at least one of the 2′-FL and the LNnT described above, in certain aspects, the nutritional product includes additional sialylated or fucosylated human milk oligosaccharides (HMOs).

Any or all of the HMO(s) used in the nutritional product may be isolated or enriched from milk(s) secreted by mammals, including, but not limited to: human, bovine, ovine, porcine or caprine species. The HMOs may also be produced via microbial fermentation, enzymatic processes, chemical synthesis or combinations thereof.

Suitable sialylated HMOs for inclusion in the infant formula may e.g. include at least one sialic acid residue in the oligosaccharide backbone. In certain aspects, the sialylated HMO includes two or more sialic acid residues.

Alternatively or additionally, the nutritional product may also contain other types of oligosaccharides such as e.g. trans-galacto-oligosaccharides (GOS), fructose-oligosaccharides (FOS), and/or polydextrose.

The nutritional product, e.g. in the form of an infant formula, may furthermore include one or more poly unsaturated fatty acids (PUFAs), such as e.g. docosahexaenoic acid (DHA), arachidonic acid (AA), eicosapentaenoic acid (EPA), docosapentaenoic acid (DPA), linoleic acid, linolenic acid (alpha linolenic acid) and gamma-linolenic acid.

Research has shown multiple roles for PUFAs in supporting brain and vision development in infants. It is the applicants' belief that inclusion of DHA and AA in the infant formula can improve neurological functions, such as cognition, learning, and memory associated with the CNS.

In certain aspects, the PUFAs are provided as free fatty acids, in triglyceride form, in diglyceride form, in monoglyceride form, in phospholipid form or as a mixture of one or more of the above, preferably in triglyceride form. The PUFAs may be derived from oil sources, such as plant oils, marine plankton, fungal oils and fish oils. In certain aspects, the PUFAs are derived from fish oils, such as menhaden, salmon, anchovy, cod, halibut, tuna or herring oil.

The nutritional product, e.g. in the form of an infant formula, may furthermore include one or more nucleotides, including e.g. the nucleotide inosine monophosphate, cytidine 5′-monophosphate, uridine 5′-monophosphate, adenosine 5′-monophosphate, guanosine 5′-1 monophosphate, more preferably cytidine 5′-monophosphate, uridine 5′-monophosphate, adenosine 5′-monophosphate and guanosine 5′-monophosphate.

The carbohydrate concentration of the nutritional product, e.g. in the form of an infant formula, may e.g. range from about 5% to about 40% w/w, including from about 7% to about 30%, including from about 10% to about 25%, by weight of the nutritional product. Where present, fat concentrations most typically range from about 1% to about 30%, including from about 2% to about 15%, and also including from about 3% to about 10%, by weight of the infant formula. Where present, protein concentrations most typically range from about 0.5% to about 30%, including from about 1% to about 15%, and also including from about 2% to about 10%, by weight of the nutritional product.

In some embodiments of the invention, the nutritional product, e.g. in the form of an infant formula, includes a source or sources of fat in addition to the PUFAs, described above. Suitable sources of fat for use herein include any fat or fat source that is suitable for use in an oral infant formula and that is compatible with the essential elements and features of such a formula.

Additional non-limiting examples of suitable fats or sources thereof for use in the nutritional product described herein include coconut oil, fractionated coconut oil, soybean oil, corn oil, olive oil, safflower oil, high oleic safflower oil, oleic acids (EMERSOL 6313 OLEIC ACID, Cognis Oleochemicals, Malaysia), MCT oil (medium chain triglycerides), sunflower oil, high oleic sunflower oil, palm and palm kernel oils, palm olein, canola oil, marine oils, fish oils, fungal oils, algae oils, cottonseed oils and combinations thereof.

The nutritional product may, in addition to milk serum protein and casein, also contain other types of protein. Non-limiting examples of suitable proteins or sources thereof for use in the nutritional product, e.g. in the form of a infant formula, include hydrolyzed, partially hydrolyzed or non-hydrolyzed proteins or protein sources, which may be derived from any known or otherwise suitable source, such as animal (e.g., meat, fish), cereal (e.g., rice, corn), vegetable (e.g., soy) or combinations thereof. Non-limiting examples of such proteins include extensively hydrolyzed casein, soy protein isolates, and soy protein concentrates.

The nutritional product may for example contain a hydrolyzed protein, i.e., a protein hydrolysate. In this context, the terms “hydrolyzed protein” or “protein hydrolysates” are used interchangeably and include extensively hydrolyzed proteins, wherein the degree of hydrolysis is most often at least about 20%, including from about 20% to about 80%, and also including from about 30%) to about 80%), even more preferably from about 40%> to about 60%>. The degree of hydrolysis is the extent to which peptide bonds are broken by a hydrolysis method. The degree of protein hydrolysis for purposes of characterizing the extensively hydrolyzed protein component of these embodiments is easily determined by one of ordinary skill in the formulation arts by quantifying the amino nitrogen to total nitrogen ratio (AN/TN) of the protein component of the selected liquid formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

Suitable hydrolyzed proteins include soy protein hydrolysate, casein protein hydrolysate, whey protein hydrolysate, rice protein hydrolysate, potato protein hydrolysate, fish protein hydrolysate, egg albumen hydrolysate, gelatin protein hydrolysate, combinations of animal and vegetable protein hydrolysates, and combinations thereof. Particularly preferred protein hydrolysates include whey protein hydrolysate and hydrolyzed sodium caseinate.

The nutritional product may, in addition to the milk saccharide, contain additional carbohydrate. Non-limiting examples of suitable carbohydrates or sources thereof include maltodextrin, hydrolyzed or modified starch or cornstarch, glucose polymers, corn syrup, corn syrup solids, ricederived carbohydrates, pea-derived carbohydrates, potato-derived carbohydrates, tapioca, sucrose, fructose, lactose, high fructose corn syrup, honey, sugar alcohols (e.g., maltitol, erythritol, sorbitol), artificial sweeteners (e.g., sucralose, acesulfame potassium, stevia) and combinations thereof. A particularly desirable carbohydrate is a low dextrose equivalent (DE) maltodextrin.

The casein source is typically added to the ALA-enriched whey protein composition in an amount sufficient to obtain the desired weight ratio between casein and milk serum protein in the nutritional product. In some preferred embodiments of the invention, the ALA-enriched whey protein composition and the casein source are mixed so as to obtain a weight ratio between milk serum protein and casein in the range of 1-9, preferably 1-3, and even more preferably 1.2-1.9, such as approx. 1.5.

In the context of the present invention, the weight ratio between two components A and B is determined as the weight of component A divided by the weight of components B. Thus, if a composition contain 9% w/w A and 6% w/w B, the weight ratio would be 9%/6%=1.5.

An advantage of the present method is that it is much faster than comparable methods for non-aggregated BLG crystallisation of the prior art. The duration from the initial adjustment of the whey protein feed to the completion of the separation of step c may be at most 10 hours, preferably at most 4 hours, more preferably at most 2 hours, and even more preferably at most 1 hour.

### EXAMPLES

### Example 1—Methods of Analysis

### Example 1.1: Determination Total Protein

The total protein content (true protein) of a sample is determined by:

1) Determining the total nitrogen of the sample following ISO 8968-1/2|IDF 020-1/2-Milk-Determination of nitrogen content—Part 1/2: Determination of nitrogen content using the Kjeldahl method.
2) Determining the non-protein nitrogen of the sample following ISO 8968-4|IDF 020-4-Milk-Determination of nitrogen content—Part 4: Determination of non-protein-nitrogen content.
3) Calculating the total amount protein as (m_{total nitrogen}−m_{non-protein-nitrogen})*6.38.

### Example 1.2: Determination of Non-Aggregated BLG, ALA, and CMP

The content of non-aggregated alpha-lactalbumin (ALA), beta-lactoglobulin (BLG) and caseinomacropeptide (CMP), respectively was analysed by HPLC analysis at 0.4 mL/min. 25 microL filtered sample is injected onto 2 TSKgel3000PWxl (7.8 mm 30 cm, Tosohass, Japan) columns connected in series with attached pre-column PWxl (6 mm×4 cm, Tosohass, Japan) equilibrated in the eluent (consisting of 465 g Milli-Q water, 417.3 g acetonitrile and 1 mL triflouroacetic acid) and using a UV detector at 210 nm.

Quantitative determination of the contents of native alpha-lactalbumin (Cₐₗₚₕₐ), beta-lactoglobulin (C_{beta}), and caseinomacropeptide (C_{CMP}) was performed by comparing the peak areas obtained for the corresponding standard proteins with those of the samples.

The total amount of additional protein (non-BLG protein) was determined by subtracting the amount of BLG from the amount of total protein (determined according to Example 1.1)

### Example 1.3: Determination of Turbidity

Turbidity is the cloudiness or haziness of a fluid caused by large number of particles that are generally invisible to the naked eye, similar to smoke in air.

Turbidity is measured in nephelometric turbidity units (NTU).

20 mL beverages/samples were added to NTU-glass and placed in the Turbiquant® 3000 IR Turbidimeter. The NTU-value was measured after stabilisation and repeated twice.

### Example 1.4: Determination of Viscosity

The viscosity of beverage preparations was measured using a Rheometer (Anton Paar, Physica MCR301).

3.8 mL sample was added to cup DG26.7. Samples were equilibrated to 22° C., then presheared for 30 sec. at 50 s⁻¹, followed by a 30 sec. equilibrium time and shear rate sweeps between 1 s⁻¹ and 200 s⁻¹ and 1 s⁻¹ were performed.

The viscosity is presented in the unit centipoise (cP) at a shear rate of 100 s⁻¹ unless otherwise stated. The higher the measured cP values, the heiger the viscosity.

Alternatively, the viscosity was estimated using a Viscoman by Gilson and reported at a shear rate of about 300 s⁻¹

### Example 1.5: Determination of Ash Content

The ash content of a food product is determined according to NMKL 173:2005 “Ash, gravimetric determination in foods”.

### Example 1.6: Determination of Conductivity

The “conductivity” (sometimes referred to as the “specific conductance”) of an aqueous solution is a measure of the ability of the solution to conduct electricity. The conductivity may e.g. be determined by measuring the AC resistance of the solution between two electrodes and the result is typically given in the unit milliSiemens per cm (mS/cm). The conductivity may for example be measured according to the EPA (the US Environmental Protection Agency) Method No. 120.1.

Conductivity values mentioned herein have been normalised to 25 degrees C. unless it is specified otherwise.

The conductivity is measured on a Conductivity meter (WTW Cond 3210 with a tetracon 325 electrode).

The system is calibrated as described in the manual before use. The electrode is rinsed thoroughly in the same type of medium as the measurement is conducted on, in order to avoid local dilutions. The electrode is lowered into the medium so that the area where the measurement occurs is completely submerged. The electrode is then agitated so that any air trapped on the electrode is removed. The electrode is then kept still until a stable value can be obtained and recorded from the display.

### Example 1.7: Determination of the Total Solids of a Solution

The total solids of a solution may be determined according NMKL 110 2^{nd} Edition, 2005 (Total solids (Water)—Gravimetric determination in milk and milk products). NMKL is an abbreviation for “Nordisk Metodikkomité for Nringsmidler”.

The water content of the solution can be calculated as 100% minus the relative amount of total solids (% w/w).

### Example 1.8: Determination of pH

All pH values are measured using a pH glass electrode and are normalised to 25 degrees C. The pH glass electrode (having temperature compensation) is rinsed carefully before and calibrated before use. When the sample is in liquid form, then pH is measured directly in the liquid solution at 25 degrees C. When the sample is a powder, 10 gram of a powder is dissolved in 90 ml of demineralised water at room temperature while stirring vigorously. The pH of the solution is then measured at 25 degrees C.

### Example 1.9: Determination of the Water Content of a Powder

The water content of a food product is determined according to ISO 5537:2004 (Dried milk-Determination of moisture content (Reference method)).

### Example 1.10: Determination of the Amounts of Calcium, Magnesium, Sodium, Potassium, Phosphorus (ICP-MS Method)

The total amounts of calcium, magnesium, sodium, potassium, and phosphorus are determined using a procedure in which the samples are first decomposed using microwave digestion, and then the total amount of mineral(s) is determined using an ICP apparatus.

Apparatus:

The microwave is from Anton Paar and the ICP is an Optima 2000DV from PerkinElmer Inc.

Materials:

1 M HNO₃

Yttrium in 2% HNO₃

Suitable standards for calcium, magnesium, sodium, potassium, and phosphorus in 5% HNO₃

Pre-Treatment:

Weigh out a certain amount of powder and transfer the powder to a microwave digestion tube. Add 5 mL 1M HNO₃. Digest the samples in the microwave in accordance with microwave instructions. Place the digested tubes in a fume cupboard, remove the lid and let volatile fumes evaporate.

Measurement Procedure:

Transfer pre-treated sample to DigiTUBE using a known amount of Milli-Q water. Add a solution of yttrium in 2% HNO₃ to the digestion tube (about 0.25 mL per 50 mL diluted sample) and dilute to known volume using Milli-Q water. Analyse the samples on the ICP using the procedure described by the manufacturer.

A blind sample is prepared by diluting a mixture of 10 mL 1M HNO₃ and 0.5 mL solution of yttrium in 2% HNO₃ to a final volume of 100 mL using Milli-Q water.

At least 3 standard samples are prepared having concentrations which bracket the expected sample concentrations.

### Example 1.11: Determination of the Furosine-Value

The furosine value is determined as described in “Maillard Reaction Evaluation by Furosine Determination During Infant Cereal Processing”, Guerra-Hernandez et al, Journal of Cereal Science 29 (1999) 171-176, and the total amount of protein is determined according to Example 1.1. The furosine value is reported in the unit mg furosine per 100 g protein.

### Example 1.12: Determination of the Crystallinity of BLG in a Liquid

The following method is used to determine the crystallinity of BLG in a liquid having a pH in the range of 5-6.

a) Transfer a 10 mL sample of the liquid in question to a Maxi-Spin filter with a 0.45 micron pore size CA membrane.
b) Immediately spin the filter at 1500 g for 5 min. keeping the centrifuge at 2 degrees C.
c) Add 2 mL cold Milli-Q water (2 degrees C.) to the retentate side of the spin filter and immediately, spin the filter at 1500 g for 5 min while keeping the centrifuge cooled at 2 degrees C., collect the permeate (permeate A), measure the volume and determine non-aggregated BLG concentration via HPLC using the method outlined in Example 1.2.
d) Add 4 mL 2 M NaCl to the retentate side of the filter, agitate quickly and allow the mixture to stand for 15 minutes at 25 degrees C.
e) Immediately spin the filter at 1500 g for 5 min and collect the permeate (permeate B)
f) Determine the total weight of non-aggregated BLG in permeate A and permeate B using the method outlined in Example 1.2 and convert the results to total weight of non-aggregated BLG instead of weight percent. The weight of non-aggregated BLG in permeate A is referred to as m_{Permeate A} and the weight of non-aggregated BLG in permeate B is referred to as m_{Permeate B}.
g) The crystallinity of the liquid with respect to BLG is determined as:

crystallinity=m_{Permeate B}/(m_{Permeate A}+m_{Permeate B})*100%

### Example 1.13: Determination of the Crystallinity of BLG in a Dry Powder

This method is used to determine the crystallinity of BLG in a dry powder.

a) 5.0 gram of the powder sample is mixed with 20.0 gram of cold Milli-Q water (2 degrees C.) and allowed to stand for 5 minute at 2 degrees C.
b) Transfer the sample of the liquid in question to a Maxi-Spin filter with a 0.45 micron CA membrane.
c) Immediately spin the filter at 1500 g for 5 min. keeping the centrifuge at 2 degrees C.
d) Add 2 mL cold Milli-Q water (2 degrees C.) to the retentate side of the spin filter and immediately, spin the filter at 1500 g for 5 min, collect the permeate (permeate A), measure the volume and determine non-aggregated BLG concentration via HPLC using the method outlined in Example 1.2 and convert the results to total weight of non-aggregated BLG instead of weight percent. The weight of non-aggregated BLG in permeate A is referred to as m_{Permeate A}
f) The crystallinity of BLG in the powder is then calculated using the following formula:

$$crystallinity = \frac{{m}_{BLG total} - {m}_{p e r meate} A}{{m}_{BLG total}} * 100 \%$$

where m_{BLG total} is the total amount of non-aggregated BLG in the powder sample of step a).

If the total amount of non-aggregated BLG of powder sample is unknown, this may be determined by suspending another 5 g powder sample (from the same powder source) in 20.0 gram of Milli-Q water, adjusting the pH to 7.0 by addition of aqueous NaOH, allowing the mixture to stand for 1 hour at 25 degrees C. under stirring, and finally determining the total amount of non-aggregated BLG of the powder sample using Example 1.2.

### Example 1.14: Determination of UF Permeate Conductivity

15 mL of sample is transferred to an Amicon Ultra-15 Centrifugal Filter Units with a 3 kDa cut off (3000 NMWL) and centrifugated at 4000 g for 20-30 minutes or until a sufficient volume of UF permeate for measuring conductivity is accumulated in the bottom part of the filter units. The conductivity is measured immediately after centrifugation. The sample handling and centrifugation are performed at the temperature of the source of the sample.

### Example 1.15: Detection of Dried BLG Crystals in a Powder

The presence of dried BLG crystals in a powder can be identified the following way:

A sample of the powder to be analysed is re-suspended and gently mixed in demineralised water having a temperature of 4 degrees C. in a weight ratio of 2 parts water to 1 part powder, and allowed to rehydrate for 1 hour at 4 degrees C.

The rehydrated sample is inspected by microscopy to identify presence of crystals, preferably using plan polarised light to detect birefringence.

Crystal-like matter is separated and subjected to x-ray crystallography in order verify the existence of crystal structure, and preferably also verifying that the crystal lattice (space group and unit cell dimensions) corresponds to those of a BLG crystal.

The chemical composition of the separated crystal-like matter is analysed to verify that its solids primarily consists of non-aggregated BLG.

### Example 1.16: Determination of the Total Amount of Lactose

The total amount of lactose is determined according to ISO 5765-2:2002 (IDF 79-2: 2002) “Dried milk, dried ice-mixes and processed cheese—Determination of lactose content—Part 2: Enzymatic method utilizing the galactose moiety of the lactose”.

### Example 1.17: Determination of the Total Amount of Carbohydrate

The amount of carbohydrate is determined by use of Sigma Aldrich Total Carbohydrate Assay Kit (Cat MAK104-1KT) in which carbohydrates are hydrolysed and converted to furfural and hydroxyfurfurals which are converted to a chromagen that is monitored spectrophotometrically at 490 nm.

### Example 1.18: Determination of the Total Amount of Lipids

The amount of lipid is determined according to ISO 1211:2010 (Determination of Fat Content-Röse-Gottlieb Gravimetric Method).

### Example 1.19: Determination of Brix

Brix measurements were conducted using a PAL-α digital hand-held refractometer (Atago) calibrated against polished water (water filtered by reverse osmosis to obtain a conductivity of at most 0.05 mS/cm).

Approx. 500 μl of sample was transferred to the prism surface of the instrument and the measurement was started. The measured value was read and recorded.

The Brix of a whey protein solution is proportional to the content of total solids (TS) and TS (% w/w) is approx. Brix*0.85.

### Example 1.20: Determination the Number of Colony-Forming Units

The determination of the number of colony-forming units per gram sample is performed according to ISO 4833-1:2013(E): Microbiology of food and animal feeding stuffs—horizontal method for the enumeration of microorganisms—Colony-count technique at 30° C.

### Example 1.21: Determination of the Total Amount of BLG, ALA, and CMP

This procedure is a liquid chromatographic (HPLC) method for the quantitative analysis of proteins such as ALA, BLG and CMP and optionally also other protein species in a composition. Contrary to the method of Example 1.2 the present method also measures proteins that are present in aggregates and therefore provides a measure of the total amount of the protein species in the composition in question.

The mode of separation is Size Exclusion Chromatography (SEC) and the method uses 6M Guanidine HCl buffer as both sample solvent and HPLC mobile phase. Mercaptoethanol is used as a reducing agent to reduce the disulphide (S—S) in the proteins or protein aggregates to create unfolded monomeric structures.

The sample preparation is easily achieved by dissolving 10 mg protein equivalent in the mobile phase.

Two TSK-GEL G3000SWXL (7.7 mm×30.0 cm) columns (GPC columns) and a guard column are placed in series to achieve adequate separation of the major proteins in raw materials.

The eluted analytes are detected and quantified by UV detection (280 nm).

### Equipment/Materials

1. HPLC Pump 515 with manual seal wash (Waters)

### 2. HPLC Pump Controller Module II (Waters)

### 3. Autosampler 717 (Waters)

### 4. Dual Absorbance Detector 2487 (Waters)

5. Computer software capable of generating quantitative reports (Empower 3, Waters)
6. Analytical column: Two TSK-GEL G3000SWXL (7.8×300 mm, P/N: 08541). Guard Column: TSK-Guard Column SWxL (6.0×40 mm, P/N: 08543).

### 7. Ultrasonic Bath (Branson 5200)

8. 25 mm Syringe filter with 0.2 μm Cellulose Acetate membrane. (514-0060, VWR)

Procedure:

Mobile Phase:

A. Stock buffer solution.
1. Weigh 56.6 g of Na₂HPO₄, 3.5 g of NaH₂PO₄, and 2.9 g of EDTA in to a 1000 mL beaker. Dissolve in 800 mL of water.
2. Measure pH and adjust to 7.5±0.1, if necessary, with HCl (decrease pH) or NaOH (increase pH).
3. Transfer to a 1000 mL volumetric flask and dilute to volume with water.

B. 6M Guanidine HCl Mobile Phase.

1. Weigh 1146 g of Guanidine HCl in to a 2000 mL beaker, and add 200 mL of the stock buffer solution (A)
2. Dilute this solution to about 1600 mL with water while mixing with a magnetic stir bar (50° C.)
3. Adjust the pH to 7.5±0.1 with NaOH.
4. Transfer into a 2000 mL volumetric flask and dilute to volume with water.
5. Filter using the solvent filtration apparatus with the 0.22 μm membranefilter.

Calibration Standards.

Calibration standards of each protein to be quantified are prepared the following way:
1. Weigh accurately (to 0.01 mg) about 25 mg of the protein reference standard into a 10 mL volumetric flask and dissolve in 10 mL of water.
   This is the protein stock standard solution (S1) of the protein
2. Pipette 200 μl of S1 into a 20 ml volumetric flask and dilute to volume with mobile phase.
   This is the low working standard solution WS1.
3. Pipette 500 μL of S1 into a 10 mL volumetric flask and dilute to volume with mobile phase.
   This is standard solution WS2.
4. Pipette 500 μL of S1 into a 5 mL volumetric flask and dilute to volume with mobile phase.
   This is standard solution WS3.
5. Pipette 750 μL of S1 into a 5 mL volumetric flask and dilute to volume with mobile phase.
   This is standard solution WS4.
6. Pipette 1.0 mL of S1 into a 5 mL volumetric flask and dilute to volume with mobile phase.
   This is the high working standard solution WS5.
7. Using graduated disposable pipettes transfer 1.5 mL of WS1-5 into separate vials.
   Add 10 μL of 2-mercaptoethanol to each vial and cap. Vortex the solutions for 10 sec. Let the standards stay at ambient temperature for about 1 hr.
8. Filter the standards using 0.22 μm Cellulose Acetate syringe filters.

The purity of protein is measured using Kjeldahl (N×6.38) and the area % from standard solution WS5 using the HPLC.

protein (mg)=“protein standard weight”(mg)×P1×P2

### P1=P % (Kjeldahl)

P2=protein area % (HPLC)

Sample Preparation
1. Weigh the equivalent of 25 mg of protein of the original sample into a 25 mL volumetric flask.
2. Add approximately 20 mL of mobile phase and let the sample dissolve for about 30 min.
3. Add mobile phase to volume and add 167 μL of 2-mercaptoethanol to the 25 ml sample solution.
4. Sonicate for about 30 min and afterwards let the sample stay at ambient temperature for about 1½ hours.
5. Mix the solution and filter using 0.22 μl Cellulose Acetate syringe filters.

HPLC System/Columns

Column Equilibration
1. Connect the GPC guard column and the two GPC analytical columns in series.
   New columns are generally shipped in a phosphate-salt buffer.
2. Run water through a new column gradually from 0.1 to 0.5 mL/min in 30 to 60 mins.
   Continue flushing for about 1 hour.
3. Gradually decrease flow rate from 0.5 mL/min to 0.1 mL/min and replace with mobile phase in the reservoir.
4. Increase pump flow rate gradually from 0.1 to 0.5 mL/min in 30 to 60 mins to avoid pressure shock and leave at 0.5 mL/min.
5. Inject ten samples to allow the column to be saturated and wait for the peaks to elute.
   This will aid in the conditioning of the column.
   This step is done without the need of waiting for each injection to be complete before injecting the next.
6. Equilibrate with the mobile phase at least 1 hour.

Calculation of the Results

Quantitative determination of the contents of the proteins to be quantified, e.g. alpha-lactalbumin, beta-lactoglobulin, and caseinomacropeptide, is performed by comparing the peak areas obtained for the corresponding standard proteins with those of the samples. The results are reported as g specific protein/100 g of the original sample or weight percentage of the specific protein relative to the weight of the original sample.

### Example 2: Enrichment of Alpha-Lactalbumin in Whey by Removal Beta-Lactoglobulin by Crystallization

Protocol:

Lactose-depleted UF retentate derived from sweet whey from a standard cheese production process was subjected to microfiltration using a 1.2 micron membrane and was subsequently used as feed for the BLG crystallization process. The sweet whey feed was conditioned using an ultrafiltration setup with a Koch HFK-328 type membrane with a 46 mill spacer, using a feed pressure of 1.5-3.0 bar, a feed concentration of 21% TS (total solids) ±5, and polished water (water filtered by reverse osmosis) as diafiltration medium. The pH was then adjusted by adding HCl to obtain a pH of approx. 5.40. Diafiltration continued until the drop in conductivity of the retentate was below 0.03 mS/cm over a 20 min period. The retentate was then concentrated to approx. 30% TS (approx. 23.1% total protein relative to the total weight of the concentrated retentate). The preparation of the concentrated retence was performed at a temperature of 10-12 degrees C. A sample of the concentrated retentate was centrifuged at 3000 g for 5 minutes but no visible pellet was formed. The supernatant was subjected to HPLC analysis. The composition of the feed can be seen in Table 1.

It should be noted that all concentrations of specific proteins such as BLG and ALA in this example pertain to the concentrations of the non-aggregated proteins and are measured according to Example 1.2.

The concentrated retentate was seeded with 0.5 g/L pure BLG crystal material obtained from a spontaneous BLG crystallization (as described in PCT application no. PCT/EP2017/084553, Example 3). The seeding material was prepared by washing a BLG crystal slurry 5 times in MilliQ water, and collecting the BLG crystals after each wash. After washing, the BLG crystals were freeze dried, grounded up using a pestle and mortar, and then passed through a 200 micron sieve. The crystallization seeds therefore had a particle size of less than 200 micron.

The concentrated retentate was transferred to a 300 L crystallization tank where it was cooled to about 2 degrees C. and kept at this temperature overnight with gentle stirring. Next morning, a sample of the cooled concentrated retentate was transferred to a test tube and inspected both visually and by microscopy. Rapidly sedimenting crystals had clearly formed overnight. A lab sample of the mixture comprising both crystals and mother liquor was further cooled down to 0 degrees C. in an ice water bath. The mother liquor and the crystals were separated by centrifugation at 3000 g for 5 minutes, and samples of the supernatant and pellet were taken for HPLC analysis. The crystals were washed once in cold polished water and then centrifuged again before freeze-drying.

TABLE 1
Concentration of selected components of the
feed standardized to 95% w/w total solids.

| Feed standardized to 95% TS | |
|---|---|
| Protein composition (% w/w relative to total | |
| protein) | |
| ALA | 17.7 |
| BLG | 51.6 |
| Other proteins incl. CMP | 30.7 |
| Other components (% w/w relative to total | |
| weight of the standardized feed) | |
| Ca | 0.357 |
| K | 0.200 |
| Mg | 0.058 |
| Na | 0.045 |
| P | 0.280 |
| fat | 5.6 |
| protein | 79 |

Protein Analyses:

TSK-HPLC with standards was used for the quantification of the proteins, and the total protein concentration was measured using the Kjeldahl method with a factor of 6.38.

BLG relative yield quantification by HPLC:

All samples were subjected to the same degree of dilution by adding polished water, the samples were filtered through a 0.22 μm filter. For each sample the same volume was loaded on an HPLC system with a Phenomenex Jupiter® 5 μm C4 300 Å, LC Column 250×4.6 mm, Ea. And detected at 214 nm.

The samples were run using the following conditions:

Buffer A: MilliQ water, 0.1% w/w TFA

Buffer B: HPLC grade acetonitrile, 0.085% w/w TFA

Column temperature: 40 degrees C.

Flow: 1 ml/min

Gradient: 0-30 minutes 82-55% A and 18-45% B; 30-32 minutes 55-10% A and 45-90% B; 32.5-37.5 minutes 10% A and 90% B; 38-48 minutes 10-82% A and 90-18% B.

Data Treatment:

As all samples were treated in the same way we can directly compare the area of the BLG peaks to gain a relative yield. As the crystals only contain BLG and the samples all have been treated in the same way the concentration of alpha-lactalbumin (ALA) and hence the area of ALA should be the same in all of the samples, therefore the area of ALA before and after crystallization is used as a correction factor (cf) when calculating the relative yield.

$$c {f}_{α} = \frac{area of {ALA}_{b efore crystallization}}{area of {ALA}_{after crystallization}}$$

The relative yield is calculated by the following equation:

$$Yiel {d}_{B L G} = ( 1 - \frac{c {f}_{α} \times area of {BLG}_{b efore crystallization}}{area of {BLG}_{after crystallization}} ) \times 100$$

Enrichment of other proteins in the mother liquor:

The protein composition in the feed was measured and the protein composition in the mother liquor was calculated, based on the conservation of mass and the knowledge the relative removal of BLG, with the assumption that no other proteins than BLG was removed. So that:

$${m}_{BLG in crystals} = {m}_{BLG feed} \times \frac{{Yield}_{BLG}}{100}$$

$${m}_{protien ML} = {m}_{protein feed} - {m}_{BLG in crystals}$$

$${m}_{ALA feed} = {m}_{ALA ML}$$

$$\% {ALA}_{feed} = \frac{{m}_{ALA feed}}{{m}_{protein feed}} \times 100$$

$$\% {ALA}_{ML} = \frac{{m}_{ALA feed}}{{m}_{protein ML}} \times 100$$

$$\% {enrichment}_{ALA} = \frac{\% {ALA}_{ML} - \% {ALA}_{feed}}{\% {ALA}_{feed}} \times 100 \%$$

Results:

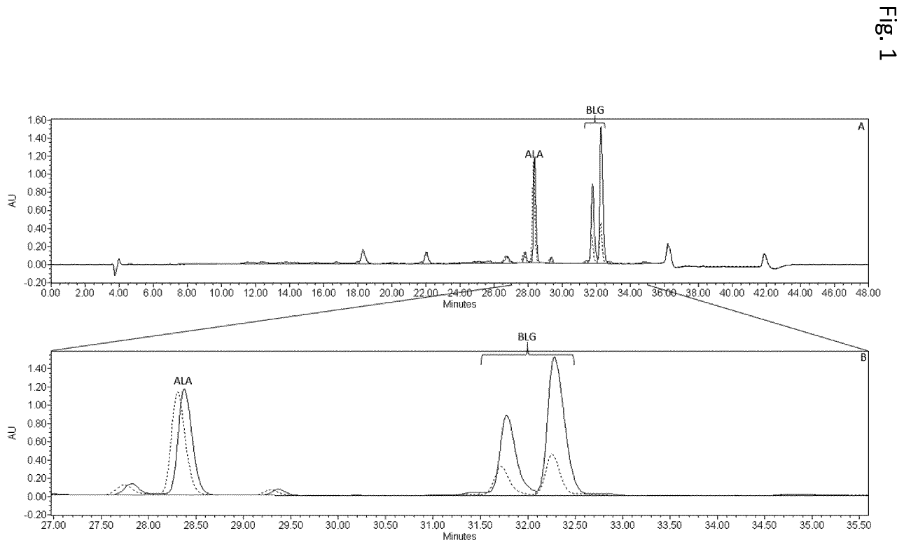

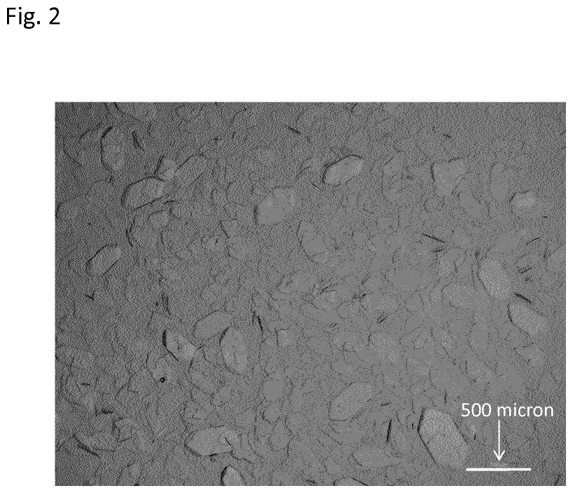

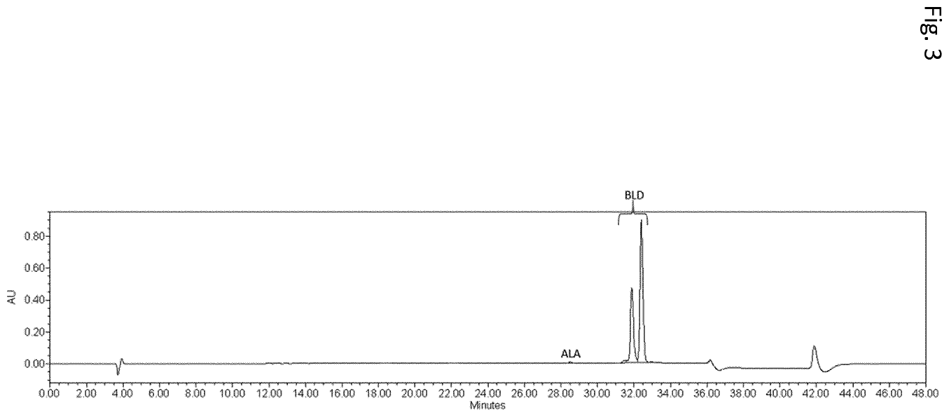

FIG. 1 shows the overlaid chromatograms from before and after crystallization of BLG from a sweet whey. The “before crystallization” sample is represented by the solid black line and the “after crystallization” sample by the dotted line. It is apparent that a large decrease in the concentration of BLG has occurred, and using the yield calculation as previously described it was found that 64.5% of BLG was removed. The % ALA_{ML} was determined to 29.2% giving an enrichment of ALA of 50%. The yield of ALA was nearly 100% as hardly any ALA was removed with the BLG crystals. FIG. 2 shows a photograph of the BLG crystals and FIG. 3 shows a chromatograph of the dissolved crystals illustrating that hardly any non-BLG protein was removed with the BLG crystals.

The calculated protein composition of the mother liquor is shown in Table 2.

TABLE 2
Calculated protein composition of the mother liquor
Mother liquor standardized to 95% TS
Protein composition (% w/w relative to total
protein)

| | |
|---|---|
| ALA | 29.2 |
| BLG | 27.5 |
| Other proteins incl. CMP | 43.3 |

### CONCLUSION

This example demonstrated that surprisingly it was possible prepare ALA-enriched whey protein compositions by crystalize BLG selectively in a crude whey protein concentrate which contained more that 48% non-BLG protein relative to total protein and subsequently removing the BLG crystals. The yield of ALA was nearly 100%. This discovery opens up for a new approach for industrial milk protein separation, in which BLG is removed from ALA and the other protein components in a gentle way that preferably avoids extended exposure to high temperatures and problematic chemicals.

### Example 3: Enrichment of ALA and Other Whey Protein Species from Whey Protein Concentrate from Sweet Whey by Removal of BLG by Crystallization

Protocol:

Lactose-depleted UF retentate derived from sweet whey from a standard cheese production process was filtered through a 1.2 micron filter and subsequently subjected to fat-reduction using a Synder FR membrane. The permeate was then prepared for crystallization as described in Example 2 with the exception that no seeding was added. The composition of the feed is shown in Table 3. The data was than treated as described in Example 2.

TABLE 3
Concentration of selected components of the feed
standardized to 95% w/w total solids.

| Feed standardized to 95% TS Protein | |
|---|---|
| composition (% w/w relative to total protein) | |
| ALA | 12.2 |
| BLG | 70.0 |
| Other proteins incl. | |
| CMP | 17.8 |
| Other components (% w/w relative to the | |
| total weight of the standardized feed) | |
| Ca | 0.387 |
| K | 0.204 |
| Mg | 0.066 |
| Na | 0.051 |
| P | 0.174 |
| Fat | BDL |
| protein concentration | 89 |

It should be noted that all concentrations of specific proteins such as BLG and ALA in this example pertain to the concentrations of non-aggregated proteins and are measured according to Example 1.2.

Results:

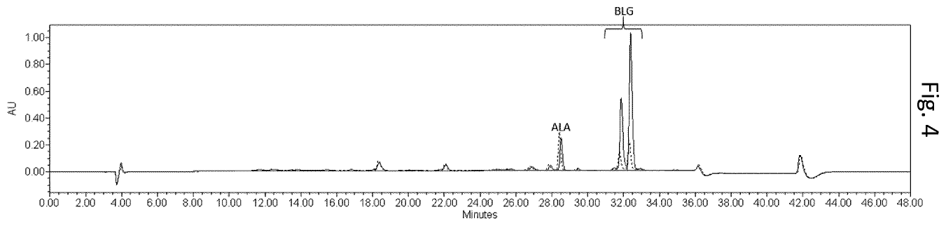

In FIG. 4 the protein composition of the feed and the mother liquor can be seen. It is evident that a large portion of BLG has been removed, calculating the yield as described in Example 2 gives a yield of 82% of BLG. The % ALA_{ML} was determined to 29.6% giving an enrichment of 143%. The protein composition of the mother liquor is shown in Table 4.

TABLE 4
Calculated protein composition of the mother liquor.
Mother Liquor standardized to 95% TS
Protein composition (% w/w relative to total
protein)

| | |
|---|---|
| ALA | 29.6 |
| BLG | 28.6 |
| Other proteins incl. CMP | 41.8 |

### Example 4: Enrichment of ALA and Other Whey Protein Species from Whey Protein Concentrate from Acid Whey by Removal of BLG by Crystallization

Protocol:

An acid whey was used as raw material and was treated as described in Example 2 The feed was subjected to crystallisation as described in Example 2 and the results were characterised and analysed as described in Example 2. The concentration of selected components of the feed can be seen in Table 5.

TABLE 5
Concentration of selected components of the
feed standardized to 95% w/w total solids.

| Feed standardized to 95% TS | |
|---|---|
| Protein composition (% w/w relative to total | |
| protein) | |
| ALA | 24.0 |
| BLG | 63.6 |
| Other proteins incl. | |
| CMP | 12.4 |
| Other components (% w/w relative to the | |
| total weight of the standardized feed) | |
| Ca | 0.289 |
| K | 0.131 |
| Mg | 0.020 |
| Na | 0.394 |
| P | 0.327 |
| fat | 5.1 |
| protein concentration | 79 |

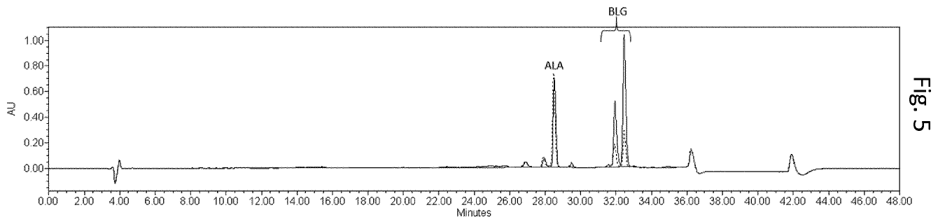

In FIG. 5 the protein composition of the feed and the mother liquor can be seen. It is evident that a large portion of BLG has been removed. The BLG yield by crystal separation was determined to 70.3%. If the concentration of total protein had been higher before crystallization, the yield would have been even higher. From this example the ALA was enriched 81% resulting in an ALA percent of 43.4. The protein composition of the remaining whey protein solution (the mother liquor) is shown in Table 6.

TABLE 6
Calculated protein composition of the mother liquor.
Mother liquor standardized to 95% TS
Protein composition (% w/w relative to total
protein)

| | |
|---|---|
| ALA | 43.4 |
| BLG | 34.2 |
| Other proteins incl . | |
| CMP | 22.4 |

It should be noted that all concentrations of specific proteins such as BLG and ALA in this example pertain to the concentrations of the non-aggregated proteins.

In addition to an increased level of ALA, the recovered mother liquor furthermore contains the phospholipid-rich whey fat and the immunoglobulins of the original whey protein feed. These are perceived to be nutritionally valuable components in infant nutrition, e.g. with respect to the development of cognitive functions and the immune system of an infant. Whey protein compositions prepared from the recovered mother liquor is therefore particularly well-suited as an ingredient in humanized infant nutrition products.

### Example 5: Enrichment of ALA and Other Whey Protein Species from Whey Protein Concentrate from Serum Protein by Removal of BLG by Crystallization

Using skimmed milk as a raw material the casein was removed via a Synder FR membrane. The permeate was then prepared for crystallization as described in Example 2, the data was also treated as described in Example 2.

### see Table 7.

TABLE 7
Concentration of selected components of the feed
standardized to 95% w/w total solids.

| Feed standardized to 95% TS Protein composition | |
|---|---|
| (% w/w relative to total protein) | |
| ALA | 23.5 |
| BLG | 66.7 |
| other proteins | 9.8 |
| Other components (% w/w relative to the | |
| total weight of the standardized feed) | |
| Ca | 0.292 |
| K | BDL |
| Mg | 0.042 |
| Na | BDL |
| P | 0.149 |
| Fat | BDL |
| protein concentration | 91 |

It should be noted that all concentrations of specific proteins such as BLG and ALA in this example pertain to the concentrations of the non-aggregated proteins.

Again it was observed that a large portion of BLG had been removed. The yield of BLG was determined to 70.0%. If the total solids of the concentrated retentate had been higher before and/or during the crystallization, the yield would have been even higher. In the present example ALA was enriched by 88% resulting in an ALA content in the mother liquor of 44.1% w/w relative to total protein. The calculated protein composition of the mother liquor is shown in Table 8.

TABLE 8
Calculated protein composition of the mother
liquor. Mother liquor standardized to 95% TS
Protein composition (% w/w relative to total
protein)

| | |
|---|---|
| ALA | 44.1 |
| BLG | 37.5 |
| Other proteins | 18.4 |

Conclusion:

It was possible to significantly enrich the ALA portion of the protein from all feeds tested using the method of the invention and thereby providing an ALA-enriched whey protein product that can be used as an ALA ingredient as such or can be subjected to further enrichment.

### Example 6—UF-DCF Aided Crystallization

Milk serum prepared by microfiltration of skimmed milk (using a Synder FR membrane for microfiltration) as used as feed for the process described in Example 2 with the exception that the pH during diafiltration is 5.92, not 5.40, and that the final total solids is 20% w/w.

After the feed is conditioned (the feed composition can be seen in Table 9) it is transferred to a 300 L crystallization tank and pH is initially adjusted to pH 5.80 and the temperature is kept around 10-12 degrees C. After pH adjustment seeding material produced in the same fashion as described in Example 2, but originating from a non-spontaneous crystallization production, is added. The feed is seeded with a concentration of 0.5 g seeding material per liter feed. After seeding the temperature on the cooling cape is set to 5 degrees C. and the pH is slowly adjusted to 5.50 and left to crystallize for approximately one hour after which the DCF (Dynamic Crossflow Filtration) is connected to the crystallization tank as shown in FIG. 6. Retentate from the DCF is returned to the crystallization tank while the permeate is used as feed for a UF unit equipped with a Koch HFK-328 type membrane with a 46 mill spacer. The DCF unit is fitted with a Kerafol ceramic membranes having a pore size of 500 nm. The trans membrane pressure (TMP) is set to 0.4 bar and the rotational speed of the membrane is 32 Hz.

Retentate from the DCF is returned to the crystallization tank, while the permeate is used as feed in a UF (ultrafiltration) unit equipped with a Koch HFK-328 type membrane with a 46 mil spacer. In the UF unit, temperatures is allowed to rise up to but not above 12 degrees C. The amount of diafiltration water added is adjusted so that retentate coming out of the UF unit and going back into the crystallization tank is about 21% TS while minerals are removed from the mother liquor. Diafiltration of the mother liquor continues until the difference in conductivity between the permeate and the diafiltration water is below 50 microS/cm. At this point the amount of diafiltration water is adjusted so that the retentate is around 30% TS. The amount of total solids of the mother liquor decreases as BLG is removed as crystals, this continuous removal of excess water and minerals makes it possible to increase the BLG yield as the concentration of non-BLG proteins during BLG crystallization appears to have a limited effect on the solubility of BLG. The estimated composition of the mother liquor from the DCF (the DCF permeate) can be seen in Table 10. The initial 300 L of feed is reduced to around 100 L of mother liquor. Based on mass conservation the relative yield of BLG is estimated to 94% and the concentration of ALA relative to total protein is estimated to increase 267 percent relative to the concentration of ALA of the feed.

TABLE 9
Concentration of selected components
of the feed standardized

| to 95% w/w total solids. Feed standardized | |
|---|---|
| to 95% TS Protein composition (% w/w | |
| relative to total protein) | |
| ALA | 23.5 |
| BLG | 66.7 |
| Other protein | 9.8 |
| Other components (% w/w relative to total | |
| weight of the standardized feed) | |
| Ca | 0.292 |
| K | BDL |
| Mg | 0.042 |
| Na | BDL |
| P | 0.149 |
| Fat | BDL |
| protein | 91 |

It should be noted that all concentrations of specific proteins such as BLG and ALA in this example pertain to the concentrations of the non-aggregated proteins and are measured according to Example 1.2.

TABLE 10
Estimated protein composition of the mother liquor.
Mother liquor standardized to 95% TS
Protein composition (% w/w relative to
total protein)

| | |
|---|---|
| ALA | 63.2 |
| BLG | 10.5 |
| Other protein | 26.3 |

Conclusion:

By continuously removing excess minerals and water from the matrix where the BLG crystallisation takes place, the ALA enrichment can be significantly improved and the process can be done at low temperatures.

### Example 7: Solving the Processing Problems of the Mother Liquor by Acidification

The inventors had previously seen indications that direct concentration and spray-drying of mother liquor gave rise to fouling issues and membrane blocking and required a significant heat-treatment to bring the microbial load to an acceptable level. The resulting dried powder would suffer from a poor protein solubility due to the relatively harsh heat-treatment required.

pH adjustment of mother liquor from 5.5 to 3.2

730 kg of mother liquor was recovered from a crystallization similar to that outlined in Example 3 and stored at 5 degrees C. overnight. The recovered mother liquor contained approx. 4.6% w/w protein and had the chemical composition shown in Table 11 Error! Reference source not found. The mother liquor was pH adjusted to pH 3.2 by slowly addition of diluted phosphoric acid. This step was performed to dissolve the remained BLG crystals. The bacterial analysis of mother liquor at initial pH and after pH adjustment was analyzed according to Example 1.20 and the results are shown in Table 12.

TABLE 11
Chemical composition of selected components of the mother
liquor (standardized to 95% total solid)

| Component | % w/w |
|---|---|
| Protein | 85 |
| Ca | 0.59 |
| Cl | 0.75 |
| Fat | 0.75 |
| K | 0.41 |
| Mg | 0.11 |
| Na | 0.10 |
| P | 0.30 |

Interestingly, it was observed that the turbidity changed from 86.8 NTU (in the mother liquor) to 23.7 NTU (in the pH-adjusted mother liquor).

Bacterial Removal of Mother Liquor During Microfiltration Step

In order to remove the bacteria, mother liquor at pH of approx. 3.2 was passed through 0.8 micrometer ceramic membranes (Pall Membralox GP). The microfiltration step was performed at operating temperature of approx. 10 degree C. where the transmembrane pressure was 3.2 bar and permeate flow was fixed to be 60 L/h/membrane. The permeate was collected for further processing. At the end of the MF step, MF permeate was collected having the turbidity of around 15.2 NTU. The permeate was analysed according to Example 1.20.

Process of Mother Liquor During Ultrafiltration Step

The collected permeate from the microfiltration step was filtered using a spiral wound GR82PE UF membrane (molecular weight cut-off of 5 kDa) with 48 mill spacer. During the ultrafiltration step, the mother liquor was concentrated to Brix of around 16 (approx. protein in an amount of 12% w/w). In order to circumvent the pH changes during the filtration step, additional phosphoric acid was added.

In this step, a concentration factor of 3 was achieved (giving around 185 kg of concentrated MF permeate was collected). Even higher concentration factor could be obtained if the the filtration was continued. In this example, feed with the approx. brix and pH of 16.5 and 3.3, respectively, was collected to be sent to spray dryer. The mother liquor at acidic pH after ultrafiltration step was analysed according to Example 1.20.

Drying of pH-Adjusted, Concentrated Mother Liquor

A portion of pH-adjusted, concentrated mother liquor was dried using a spray dryer with an inlet temperature of 185 C degree and outlet temperature of approx. 85 C degree. The resulting powder (approx. 15 Kg) had a water content of approx. 4.0% w/w. The content of microorganisms was analysed according to Example 1.20.

Results:

As can be seen from Table 12, addition of acid to adjust the pH of mother liquor from approx. 5.5 to 3.2 resulted in decreasing the total plate count around ten times. In addition, microfiltration step could successfully remove the bacteria as the total plate count of the permeate was reduced to <1000 CFU/g. After spray drying the final mother liquor powder at pH 3.2 had total plate count of 10 CFU/g.

TABLE 12
Concent of microorganisms (CFU/g) after each process step

| | Before | After | After | After | After |
|---|---|---|---|---|---|
| | acid | acid | MF | UF | spray dryer |
| | addition | addition | step | step | (as a powder) |
| Total plate count | 3,700,000 | 460,000 | 40 | 590 | 10 |
| (CFU/g) | | | | | |

In addition, mother liquor after pH adjustment to 3.2 was kept for three days at 5 degree C. storage. The total plate count has been reduced from 460,000 CFU/g to 350,000 CFU/g. Reduction of the total plate count of the sample before and after storage showed that keeping the mother liquor at acidic pH of 3.2 will lead to inhibit the growth of the bacteria too.

Conclusion:

Acidification in order to produce the mother liquor powder at pH 3.2 gave rise to a significant bacterial load reduction. In addition, the turbidity of the mother liquor was reduced from about 87 to 24 NTU which is believed to be the result of dissolving the BLG crystals and/or microbial load reduction in mother liquor.

Further, microfiltration of mother liquor led to successful bacterial removal. In addition, using the final powder at pH of approx. 3.2 has a transparent appearance and a turbidity below 50 NTU. Consequently, the acidic powder derived from the mother liquor conditioned may be used in beverage and instant beverage applications, e.g. for pediatric nutrition.

### Example 8: Solving the Processing Problems of the Mother Liquor by Increasing the pH

400 mL mother liquor at a pH of approx. 5.5 was mixed with diluted KOH to obtain a pH of approx. 7. The pH-adjusted mother liquor was subjected to filtration step using a Synder HFK328 membrane at a transmembrane pressure of 4 bars and temperature of approx. 10 degree C. until a solids content of a brix 6 was reached.

Results:

After the ultrafiltration step the mother liquor contained 89% protein relative to total solids. Due to the pH adjustment, no fouling problems or membrane-clogging problems were encounter. The pH-adjusted, concentrated mother liquor appeared suitable for drying if concentrated to a higher total solids content or could alternatively be used directly without further modifications as an ingredient for e.g. pediatric nutrition or instant beverages.

### Example 9: Further Enrichment of ALA of the Mother Liquor

This example described further enrichment of ALA of the mother liquor.

100 L of mother liquor obtained according to Example 5 having a protein content of approx. 13.7% w/w is mixed with hydrochloric acid (8% w/v) and rapidly mixed to achieve a final pH of 4.3. The pH-adjusted mother liquor is then concentrated by ultrafiltration in a four stage, stages-in-series, ultrafiltration plant using a 5 kDa UF membrane to a protein content of approx. 22% w/w. The pH-adjusted, concentrated mother liquor is then passed through a tubular heat exchanger in which the temperature was slowly increased to 64 degrees C.±1 degrees C. and then through a tube maintained at the same temperature of length equivalent to a residence time of 6 minutes. The solution is then cooled to 50 degrees C. in a second tubular heat exchanger and collected in an insulated vat fitted with agitating paddles rotated at 20 r.p.m. After an average residence time in the vat of 10 minutes, the solution is pumped at 200 L/hr through a continuous, self-desludging clarifier. The sedimented protein fraction is discharged periodically after flushing the clarifier bowl with water. The sedimented protein fraction is suspended in polished water and dissolved by adjusting the pH to 6.7 by addition of aqueous NaOH (10% w/v).

The dissolved protein fraction is concentrated by ultrafiltration using a 5 kDa membrane to approximately 25% w/w total solids content and spray dried. The ALA-enriched powder is expected to contain more than 60% w/w ALA relative to total protein and have a total protein content of at least 85% relative to the total solids of the powder. The water content is at most 5% w/w.

### Example 10: Infant Formulas Containing ALA-Enriched Whey Protein Compositions

Two infant formula products, A and B, are produced from the ALA enriched whey protein powders of Examples 4 or 9 by mixing:
6.8 kg ALA enriched whey protein powder from Example 4 (for infant formula A) or Example 9 (for infant formula B),
20.5 kg food grade lactose,
152.7 kg water
70 kg of UF concentrated skimmed milk (9.0% w/w protein, 4.2% w/w lactose, 0.05% w/w fat, 0.7% w/w ash, 14.7% w/w total solids),
374 kg demineralized UF permeate of skimmed milk,
33.2 kg vegetable fat mix,
15.1 kg GOS syrup containing 71% total solids, and
required micronutrients including vitamins, nucleotides, and poly-unsaturated fatty acids PUFA.

The blends are homogenized, pasteurized, evaporated and spray dried to produce 118 kg final Infant Formula powder with a milk serum protein/casein proportion of approx. 62/38 and an energy content of approx. 2000 kJ pr 100 g powder.

Both infant formulas mimic human breast milk better than a regular infant formula based on standard whey protein. Both infant formulas contain a higher amount ALA than a regular infant formula based on standard whey protein (especially the infant formula B). Infant formula A furthermore contains the phospholipid-rich whey fat and the immunoglobulins of the original whey protein feed, which are perceived to be nutritionally valuable components in infant nutrition, e.g. with respect to the development of cognitive functions and the immune system of an infant.

1. A method of preparing an edible, alpha-lactalbumin-enriched whey protein composition, the method comprising the steps of
a) providing a whey protein solution comprising non-aggregated beta-lactoglobulin (BLG), alpha-lactalbumin (ALA) and optionally additional whey protein, said whey protein solution being supersaturated with respect to BLG and having a pH in the range of 5-6,
b) crystallising non-aggregated BLG in the supersaturated whey protein solution, preferably in salting-in mode, and
c) separating the BLG crystals from the remaining mother liquor and recovering at least some of the mother liquor,
d) providing a first composition derived from the recovered mother liquor,
e) optionally, adjusting the pH of the first composition to
i) a pH in the range of 2.5-4.9, or
ii) a pH in the range of 6.1-8.5,
f) drying:
the first composition obtained from step d) or a protein concentrate thereof, or
the pH-adjusted first composition obtained from step e) or a protein concentrate thereof.

2. The method according to claim 1, furthermore comprising physical microbial reduction, preferably performed after the pH adjustment of e) and prior to the drying of step f).

3. The method according to any of the preceding claims, wherein the whey protein solution of step a) comprises at most 90% w/w BLG relative to the total amount of protein.

4. The method according to any of the preceding claims, wherein the whey protein solution comprises a milk serum protein concentrate, a whey protein concentrate, milk serum protein isolate, and/or whey protein isolate.

5. The method according to any of the preceding claims, wherein the ratio between the conductivity and the total amount of protein of the whey protein solution is at most 0.3.

6. The method according to any of the preceding claims, wherein the UF permeate conductivity of the whey protein solution is at most 7 mS/cm.

7. The method according to any of the preceding claims, wherein the supersaturated whey protein solution is prepared by subjecting a whey protein feed to one or more of the following adjustments:
Adjusting the pH,
Reducing the conductivity
Reducing the temperature
Increasing the protein concentration, and
Adding an agent that reduces the water activity.

8. The method according to any of the preceding claims, wherein step c) comprises separating the BLG crystals to a solids content of at least 30% w/w, preferably at least 40% w/w and even more preferably at least 50% w/w.

9. The method according to any of the preceding claims, wherein the first composition comprises, or even consists of, the recovered mother liquor.

10. The method according to any of the preceding claims, wherein the first composition comprises, or even consists of, a protein concentrate of the recovered mother liquor.

11. The method according to any of the preceding claims, wherein the provision of the first composition involves further ALA enrichment, preferably to a first composition that has a weight percentage of ALA relative to total protein that is at least 5% higher than that of the recovered mother liquor.

12. The method according to any of the preceding claims, wherein the pH of the first composition is adjusted to a pH in the range of 2.5-4.9, preferably 2.8-4.5 and more preferably 2.8-3.2

13. The method according to any of the preceding claims, wherein the pH of the first composition is adjusted to a pH in the range of 6.1-8.5, preferably 6.3-8.0, and even more preferably 6.5-7.5.

14. The method according to any of the preceding claims, wherein the physical microbial reduction involves one or more of:
heat-treatment, preferably at least pasteurization,
UV radiation treatment,
pulsed light treatment,
microfiltration,
high pressure treatment, and
ultrasound treatment.

15. An edible, ALA-enriched whey protein composition, said composition being obtainable by one or more processes according to any of the claims 1-14.

16. A method of producing a food product, the method comprising the steps of
a) providing a whey protein solution comprising non-aggregated beta-lactoglobulin (BLG), alpha-lactalbumin (ALA) and optionally additional whey protein, said whey protein solution being supersaturated with respect to BLG and having a pH in the range of 5-6,
b) crystallising non-aggregated BLG in the supersaturated whey protein solution, preferably in salting-in mode, and
c) separating the BLG crystals from the remaining mother liquor and recovering at least some of the mother liquor,
d) providing a first composition derived from the recovered mother liquor,
e) optionally, adjusting the pH of the first composition to
i) a pH in the range of 2.5-4.9, or
ii) a pH in the range of 6.1-8.5,
f) optionally, drying the first composition obtained from step d) or a protein concentrate thereof or drying the pH-adjusted first composition obtained from step e) or a protein concentrate thereof,
g) combining:
g1) the first composition obtained from step d) or a protein concentrate thereof,
g2) the pH-adjusted first composition obtained from step e) or a protein concentrate thereof, and/or
g3) the dried composition obtained from step f)
with one or more ingredients and converting the combination to a food product.

17. A food product comprising the ALA-enriched whey protein composition, e.g. obtainable by the method according to claim 16.
